(19) United States
(12) Patent Application Publication
(10) Pub. No.: US 2025/0282654 A1
(43) Pub. Date: Sep. 11, 2025

(54) Nonthermal Plasma Treatment of Contaminants in Liquid Cooling Systems for Optimal Heat Removal and Reliable Operation in Data Centers

(71) Applicant: Reverse Ionizer Systems, LLC, Bethesda, MD (US)

(72) Inventors: Desmond A. Fraser, Oak Hill, VA (US); Patrick J. Hughes, Reston, VA (US); Loraine A. Huchler, Exmore, VA (US)

(73) Assignee: Reverse Ionizer Systems, LLC, Bethesda, MD (US)

(21) Appl. No.: 19/056,716

(22) Filed: Feb. 18, 2025

Related U.S. Application Data
(63) Continuation-in-part of application No. 18/964,828, filed on Dec. 2, 2024.
Application No. 18/964,828 is a continuation of application No. 17/674,727, filed on Feb. 17, 2022.
(60) Provisional application No. 63/150,576, filed on Feb. 17, 2021.
(60) Provisional application No. 63/248,453, filed on Sep. 25, 2021.
(60) Provisional application No. 63/554,931, filed on Feb. 16, 2024.
(60) Provisional application No. 63/572,904, filed on Apr. 1, 2024.
(60) Provisional application No. 63/745,013, filed on Jan. 14, 2025.

(51) Int. Cl. C02F 1/46; C02F 1/467; C02F 103/02

(52) U.S. Cl. CPC C02F 1/4608; C02F 1/4674; C02F 2103/023; C02F 2201/46125; C02F 2303/04; C02F 2303/22

(57) ABSTRACT

Harmful contaminants are treated using plasma fields. The inventive techniques offer improved results over existing devices and methods.

### RELATED APPLICATIONS

The present application is a continuation-in-part of U.S. patent application Ser. No. 18/964,828 filed Dec. 2, 2024 (the '828 Application) which is a continuation of U.S. patent application Ser. No. 17/674,727 filed Feb. 17, 2022 (the “'727 Application”) which claims the benefit of priority from U.S. Provisional Patent Application No. 63/150,576 (the “576 Application”) filed Feb. 17, 2021 and U.S. Provisional Patent Application 63/248,453 (the “'453 Application”) filed Sep. 25, 2021. The present application also claims priority to U.S. Patent Application No. 63/554,931 filed Feb. 16, 2024 (the “'931 Application), U.S. Patent Application No. 63/745,013 filed Jan. 14, 2025 (the “'013 Application”) and U.S. Patent Application No. 63/572,904 filed Apr. 1, 2024 (the “'904 Application). The present application is also related to U.S. patent application Ser. No. 16/672,503 (the “'503 Application”) and U.S. application Ser. No. 15/926,965 (the “'965 Application). This application incorporates by reference herein the entirety of the disclosures of the '931, '013, '904, '828, '727, '576, '453, '503 and '965 Applications as if set forth herein in full.

### INTRODUCTION

This section introduces aspects that may be helpful to facilitate a better understanding of the described disclosure(s). Accordingly, the statements in this section are to be read in this light and are not to be understood as admissions about what is, or what is not, in the prior art.

Microbiological contaminants (e.g., bacteria (Legionella), biofilms, viruses, and parasites) occur in heating, ventilation and air-conditioning (HVAC) systems. Under the right environmental conditions, these contaminants can have a deleterious effect on operating systems (e.g. data center servers and associated electronics) that use HVAC coolant systems due to even a slight build-up of such microbiological contaminants, In addition, such contaminants can be hazardous to the health of individuals that are exposed to the contaminants.

Accordingly, there is a need for devices, systems and methods that effectively treat (i.e., reduce, eliminate) such contaminants.

It is believed that non-thermal plasma (NTP) techniques can be highly effective in generating reactive species (e. g. hydroxyl radicals, ozone, and reactive nitrogen species) and creating a high energy field that damages or kills microbiological contaminant microorganisms and biofilms (e.g. bacteria planktonic (free-floating) and sessile (attached to wetted surfaces) planktonic (free-floating) and sessile (attached to water-wetted surfaces), viruses, and fungi). The micro-organisms within the biofilm layer are believed to display a higher tolerance to disinfectants than their planktonic counterparts. Their increased resistance is believed to be multi-factorial resulting from phenotypic adaptation, gene transfers and mutations.

Accordingly, there is a need to develop NTP based methods and apparatuses for treating microbiological contaminant microorganisms and biofilms.

Artificial Intelligence (AI) is helping data centers optimize their energy efficiency and effectively manage power distribution. However, the increasing adoption of AI applications is also straining data centers' ability to cool the increasingly powerful and larger electronic servers (hereafter “servers”) required to run these applications. These servers contain multiple cores of electronic central processing units (CPUs) and graphical processing units (GPUs) that generate extremely high levels of heat, which must be efficiently removed from the data center server rooms to maintain a low power usage effectiveness (PUE) and ensure optimal performance.

Traditionally, data centers have relied on open-loop cooling towers and chillers to cool their server rooms. However, as the heat generated by CPUs and GPUs continues to rise, these conventional cooling methods are becoming less effective and efficient. To address this challenge, in addition to traditional open-loop cooling towers, many data centers have begun implementing advanced liquid closed-loop cooling technology to cool the high heat-generating components within the servers directly.

While closed-looped liquid cooling distribution systems reduce heat dissipation on data center servers, contaminant outbreaks (algae, bacteria, viruses, and parasites) can occur in these closed-looped systems.

Algal blooms primarily can occur in closed-looped liquid cooling distribution systems when the conditions for algal growth are favorable. Algae require light, nutrients, and a suitable temperature to grow and multiply rapidly. In liquid closed-loop systems, the temperature of the liquid is typically very warm, which is ideal for algae blooms, which can cause various problems, such as reduced heat transfer efficiency, clogged pipes and filters, and corrosion. Algae can bloom in such systems if parts of the close-looped liquid cooling distribution systems are exposed to light, particularly sunlight—which can promote algal growth. Transparent or translucent pipes, reservoirs, or heat exchangers can also allow light to penetrate the system, favoring algal growth.

Algae require nutrients, such as nitrogen and phosphorus, to grow. These nutrients can enter the closed loop system through various means, such as corrosion of system components, breakdown of organic matter, or untreated or poorly treated water.

Algae thrive in various temperatures, but most species grow best in warm water. If the liquid's temperature in the liquid cooling distribution system is within the optimal range for algal growth (typically between 20-30° C. or 68-86° F.), it can promote algal blooms.

Algae can also grow more quickly in stagnant or slow-moving water, as it allows them to access light and nutrients more readily. In closed-loop systems with low flow rates or dead zones, algae can accumulate and form blooms.

Accordingly, it is desirable to provide methods, systems and devices that effectively treat water or other coolants used in closed-loop systems to remove or substantially reduce such algae, as well as the nutrients, organic matter, or algal spores that promote algal growth.

Additional devices, systems, related methods, features and advantages of the disclosure will become clear to those skilled in the art from the following detailed description and appended drawings.

### BRIEF DESCRIPTION OF THE DRAWINGS

FIG. 1 depicts a simplified configuration illustrating a Door Heat Exchanger cooling distribution configuration according to one or more embodiments of the disclosure.

FIG. 2 depicts a simplified configuration of an Immersion Cooling, cooling distribution configuration according to an embodiment of the disclosure.

FIG. 3A depicts a simplified configuration of a Direct-to-Chip, cooling distribution configuration according to an embodiment of the disclosure.

FIG. 3B depicts a simplified configuration of a Direct-through-Chip, cooling distribution configuration according to an embodiment of the disclosure.

FIG. 4 depicts an enlarged version of an exemplary plasma disinfectant treatment section according to an embodiment.

FIG. 5 depicts an enlarged view of an exemplary plasma cell assembly that may contain one or more plasma cells according to an embodiment.

FIGS. 6A and 6B depict exemplary sections of an exemplary double dielectric barrier discharge (DDBD) plasma cell according to an embodiment.

FIGS. 7 and 8 depict exemplary configurations of cathode and anode electrodes.

FIG. 9 depicts additional, exemplary configurations of electrodes.

FIGS. 10A to 10E depicted views of an exemplary plasma cell.

FIG. 11A depicts an enlarged view of an exemplary manifold.

FIGS. 11B to 11E depict exemplary dimensions and a configuration of an exemplary manifold.

FIGS. 12A to 12C depict exemplary dimensions and a configuration of an exemplary negative electrode layer of an exemplary plasma cell.

FIGS. 13A to 13C depict exemplary dimensions and a configuration of an exemplary positive electrode layer of an exemplary plasma cell.

FIGS. 14A to 14D depict exemplary dimensions and a configuration of an exemplary transparent window layer of an exemplary plasma cell.

FIGS. 15A to 15D depict exemplary dimensions and a configuration of an exemplary protective spacer layer of an exemplary plasma cell.

FIGS. 16A to 16D depict exemplary dimensions and a configuration of an exemplary sealant layer or layers of an exemplary plasma cell.

FIGS. 17A to 17D depict exemplary dimensions of an exemplary dielectric layer or layers of an exemplary plasma cell.

FIGS. 18A to 18D depict exemplary dimensions of an exemplary cover layer of an exemplary plasma cell.

To the extent that any of the figures or text included herein depicts or describes dimensional values (e.g., inches), temperatures, pressures, pHs, conductivities and other parametric values it should be understood that such values are merely exemplary to aid the reader in understanding the embodiments described herein. It should be understood, therefore, that other values may be used to construct the inventive devices, systems and components described herein and their equivalents without departing from the scope of the disclosures.

### SUMMARY

Devices, systems and related methods for treating harmful microbiological contaminants and biofilms are presented. In one embodiment, an exemplary apparatus for applying nonthermal plasma to a liquid coolant to control contaminant growth may comprise: a plasma disinfection system that applies nonthermal plasma to a liquid coolant to control contaminant growth in the liquid coolant, the plasma disinfection system further configured to generate reactive oxygen and nitrogen species upon application of the nonthermal plasma to the liquid coolant, the plasma disinfection system further comprising: one or more dielectric barrier discharge (DBD) electrodes configured to optimize energy efficiency; an electronic controller that controls a time period that the nonthermal plasma is applied to the liquid coolant; and a neutralization unit that removes residual oxidants.

Such an apparatus may be connected to a secondary or side stream cooling distribution loop to treat the liquid coolant, and may be connected inline.

In an embodiment, the electronic controller may be further operable to control a voltage or frequency of the nonthermal plasma applied to the liquid coolant. Further, the DBD electrodes may be composed of a corrosion-resistant material, such as one of PEEK, DELRIN, titanium, or 316L stainless steel, for example.

In addition to apparatuses, the inventors provide methods for reducing biofilm and microbiological contaminants in a liquid cooling distribution system.On such exemplary method may comprise: connecting a plasma disinfection system into a liquid cooling loop of the system; applying nonthermal plasma from the plasma disinfection system to the liquid coolant to generate oxidative species including hydroxyl radicals (OH), ozone (O₃), hydrogen peroxide (H₂O₂), and singlet oxygen (¹O₂) to inactivate microbial contaminants; neutralizing excess levels of the oxidative species before re-entry into the liquid cooling loop; and monitoring the pH and the oxidation reduction potential of the liquid coolant.

Such a method may further comprise controlling the application of nonthermal plasma from the plasma disinfection system to the liquid coolant to generate hydroxyl radicals (OH), ozone (O₃), hydrogen peroxide (H₂O₂), and singlet oxygen (¹O₂) at controlled dosages withing 200 mV to 400 mV ORP levels.

In addition, such a method may comprise monitoring the conductivity or microbial load of the liquid coolant.

The inventors also provide for self-regulating apparatuses for applying nonthermal plasma to a liquid coolant to control contaminant growth comprising in data center microelectronics. On such apparatus may comprise: a real-time microbial contamination sensor for detecting a microbial load; an automated plasma power regulation module for controlling the application of nonthermal plasma to a coolant based on the detected microbial load and a quality of the liquid coolant; a dual-stage nonthermal plasma chamber that generates and applies nonthermal plasma to a liquid coolant to optimize exposure time in a cooling loop; and an electronic controller that controls the dual-stage nonthermal plasma chamber to generate nonthermal plasma over a variable plasma duty cycle to reduce energy consumption while maintaining a microbial load of 10 CFU/ml.

In addition, the electronic controller may comprise wireless circuitry for operating remotely from the chamber. An electronic communications bus for communicating electronic signals between the controller, sensors, and an inventive apparatus may be provided using a network protocol comprising one of Modbus, BACnet or SNMP, for example.

Other methods are also provided by the inventors. On such method for applying nonthermal plasma to an enhanced glycol-water coolant mixture used in a data center may comprise: applying a controlled amount of nonthermal plasma to the enhanced glycol-water coolant mixture; mitigating glycol oxidation by introducing antioxidants (BHT, TBHQ), metal chelatos (EDTA, phosphonates), and corrosion inhibitors (molybdates, benzotriazole) into the glycol-water coolant mixture; maintaining a pH of the enhanced glycol-water coolant mixture within the range of 7.5-9.0; reducing biofilm growth within the glycol-water mixture flowing to or through microcapillaries of graphical processing units (GPUs); and reducing biofilm growth within the glycol-water mixture flowing in one or more cooling distribution loops that includes one or more electronic servers.

In such a method the enhanced glycol-water coolant mixture may be composed of (i) a propylene glycol based coolant (e.g.,PG25 propylene glycol coolant) or (2) an ethylene glycol coolant.

Still further the inventors provide for modular apparatuses for applying nonthermal plasma to a liquid coolant to control contaminant growth within a closed-Loop liquid cooling distribution system of a data center, Such a modular apparatus may comprise: a plasma disinfection module connected to the closed-Loop liquid cooling distribution system; a plasma energy optimization system that minimizes power consumption based on cooling system parameters; corrosion-resistant piping that prevents oxidative degradation; a fail-safe monitoring system for plasma streamer discharge, coolant quality, and system health diagnostics; and a modular skid-mounted PDS unit for rapid deployment in new or existing data centers.

The closed-Loop liquid cooling distribution system of such a modular apparatus may comprise: (1) a Door Heat Exchanger system or Rear Door Heat Exchanger (RDHx) system, (2) a Direct-to-Chip (D2C) system or a Direct Through Chip system, or (3) an Immersion Cooling system.

### DETAILED DESCRIPTION, INCLUDING EXAMPLES

Exemplary embodiments of systems, devices and related methods for treating harmful microbiological contaminants and biofilms are described herein and are shown by way of example in the drawings. Throughout the following description and drawings, like reference numbers/characters refer to like elements.

It should be understood that, although specific exemplary embodiments are discussed herein, there is no intent to limit the scope of the present disclosure to such embodiments. To the contrary, it should be understood that the exemplary embodiments discussed herein are for illustrative purposes, and that modified and alternative embodiments may be implemented without departing from the scope of the present disclosure.

It should also be noted that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed and may also include additional steps not included in a description of the process/method.

As used herein, the term “and/or” includes any and all combinations of one or more of the associated listed items. As used herein, the singular forms “a,” “an” and “the” are intended to include the plural form, unless the context and/or common sense indicates otherwise.

As used herein, the term “embodiment” refers to an example of the present disclosure.

As used herein, the term “operable to” means “functions to”.

As used herein the terms “contaminant”, “biological contaminant”, “microbiological contaminant”, “microcontaminants”, “bio-contaminant” and “microbial contaminant” may be used interchangeably to mean unwanted biological material such as bacteria (Legionella), biofilms, viruses, parasites, fungi, algae and the nutrients, organic matter, or spores that promote the growth of such unwanted biological material.

As used herein the phrases “treat”, “treating,” “treatment” and other tenses of the word treat mean the inactivation, mitigation, reduction, removal, minimization, dissolution and elimination of harmful contaminants and biofilms the prevention of such harmful contaminants and biofilms unless the context indicates otherwise to one skilled in the art.

It should be understood that the phrases “causes the controller” “controller causes”, “at least one controller and at least one memory for storing instructions that, when executed by the controller cause” or similar phrases means an electronic processor, microcontroller, controller, programmable logic controller, addressable controller or computer (collectively “controller”) that is part of an inventive apparatus or an electronic test set that includes specialized instructions for completing associated, described features and functions, such as computations or the generation of control signals, for example. Such instructions may be stored within the “at least one memory” which may comprise an onboard memory or a separate memory device(s). Such instructions may comprise an electronic application or APP (e.g., an electronic application that is especially downloaded by a user to a mobile device) for completing one or more of the inventive functions or features described herein. Such instructions are designed to integrate specialized functions and features into the controllers and test sets that are used to complete inventive features, functions, methods and processes related to treating harmful microbiological contaminants by controlling one or more inventive systems or devices/components used in such a treatment. Such instructions, and therefore functions and features, are executed by the controllers and test sets described herein at speeds that far exceed the speed of the human mind and, therefore, such features and functions could not be completed by the human mind in the time required to make the completion of such features and functions reasonable to those skilled in the art. Further, the inventors know of no existing prior art where the human mind has been used in place of the controllers or test sets to complete the features and functions described herein. It should be understood that an “APP” may include “content” (e.g., text, audio and video files), signaling and configuration files. For the sake of convenience and not limitation, the term “APP” may be used herein to refer to any electronic application, but use of such a term also includes a reference to any file or data.

### Data Center Cooling

There are a number of methods used to cool equipment that is a part of a data center, in particular the electronic servers of a data center. Generally, such methods can be described as belonging to one of the following methods:

Cold Plate: This method typically uses a metal plate with liquid channels attached directly to heat-generating components (like CPUs or GPUs). A coolant circulates through the plate, absorbing heat and transferring it to a secondary cooling system. The cold plate can be part of a Coolant Distribution Unit (CDU) to separate a coolant from a primary distribution loop (i.e., Facility Water System (FWS)) to a secondary cooling loop. In addition, the CDU functions to ensure proper pressure, water quality, temperature, and flow to such a secondary cooling loop. CDUs can also maintain temperatures above the dew point to minimize condensation risk.

Immersion Cooling: In this method, entire servers are typically immersed in a dielectric (nonconductive), noncorrosive liquid, which cools the system directly. This is most efficient when the space available for cooling and/or servers is limited or confined. One immersion cooling technique allows a secondary cooling loop to be connected directly to the FWS, while another uses a CDU to control pressure, temperature, and water quality independently. When a CDU is used, the CDU can prevent liquid at certain temperatures (i.e., too cold) from being used to cool areas that include Information Technology Equipment (ITE) (e.g., servers, storage systems, and network devices) that are sensitive to condensation.

Door Heat Exchanger (HX): This method may typically use a number of different types of heat exchanger on a rack door—front or rear. Some “door” cooling solutions use air-to-air heat exchangers instead of liquid cooling. Some solutions integrate fans in the door to improve heat dissipation. Not all “door heat exchangers” use liquid cooling like Rear Door Heat exchangers (described elsewhere herein); some use phase-change materials or advanced air-cooling techniques. For example, one configuration connects a heat exchanger directly connected to the FWS, removing heat from air-cooled Information Technology Equipment (ITE) (e.g., servers, storage systems, and network devices) and restoring air to a condition that the ITE can operate safety reliably (i.e., meets ASHRAE TC9.9 requirements).

Direct to Chip (D2C): This method typically uses a closed-loop liquid to deliver coolant directly to microchannels within a cold plate mounted on the CPU or GPU. This method is viewed as being more targeted than cold plates alone, providing better efficiency. The liquid may be cooled using a Coolant Distribution Unit (CDU) or an external system.

Direct Through Chip: This method allows coolant to flow directly through microchannels etched into a microelectronic device (e.g., through a silicon, germanium, or other material) allowing for ultra-efficient heat removal from its source.

Rear Door Heat Exchanger (RDHx): This method typically uses a liquid-cooled heat exchanger mounted on the rear door of the server rack. As hot air exits servers, it passes through the heat exchanger, where it is cooled before being expelled into the data center. The heat exchanger typically contains water or a coolant (such as glycol) that absorbs heat and carries it away to a cooling loop (CRAC, CRAH, or a chiller system). Typically, this method is passive (no fans) or active (fans to enhance airflow). Furthermore, this method is commonly used for high-density racks (20-80 KW per rack) because it reduces the load on traditional room cooling.

To maintain the efficiency and longevity of its HVAC cooling systems, data centers make use of existing methods and chemicals to treat microbiological contaminants and biofilms, such as biocides, corrosion chemical inhibitors, maintaining pH control, mechanical physical filtration, UV filtration and regular maintenance of HVAC system components (e.g., cold plates, heat exchangers, and reservoirs).

While the above methods and chemicals are useful and can treat microcontaminants and biofilms the degree of efficiency needed to operate servers within a data center demands higher efficiencies than these existing methods and chemicals can provide.

The inventors have discovered that inventive apparatuses described herein and related methods provide such higher efficiencies.

More particularly, the inventors have discovered an inventive apparatus that treats coolant (e.g., an enhanced glycol-water coolant mixture) in a closed-loop cooling system of a data center by applying nonthermal plasma to such coolant that passes through the apparatus. The apparatus may comprise a plasma disinfection system (PDS) or another system that generates and applies nonthermal plasma to the coolant.

In embodiments, the inventive apparatus disclosed herein may be connected between a heat exchanger and a manifold of a cooling distribution system within a secondary coolant distribution loop to treat and prevent microbiological contaminant and biofilm growth (e.g., bacteria, algae, and fungi) within the coolant (e.g., an enhanced glycol-water coolant mixture) as well as on ITE connected to the secondary and primary coolant distribution systems (e.g., connected to a FWS).

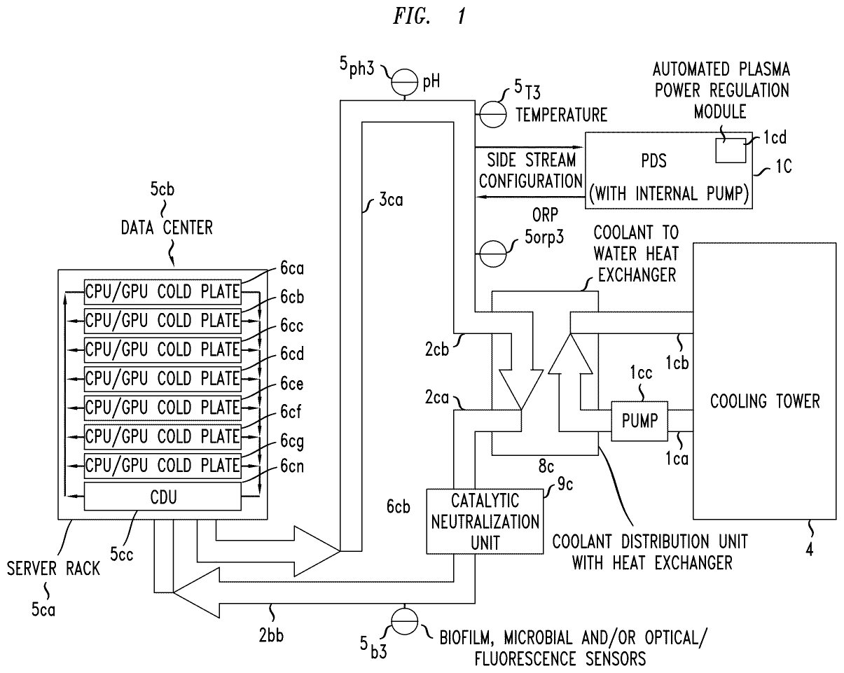

Referring now to FIGS. 1 to 3B there is shown inventive configurations that illustrate some exemplary positionings of an inventive apparatus 1A,1B,1C,1D such as a PDS, within a secondary cooling loop of a cooling distribution system, such as one used by a data center. In embodiments, each inventive apparatus 1A,1B,1C,1D may be connected between a heat exchanger and a manifold of a cooling distribution system within a secondary coolant distribution loop to treat and prevent bio-contaminant growth (e.g., bacteria, algae, and fungi) within the coolant (e.g., an enhanced glycol-water coolant mixture) as well as on ITE connected to the secondary and primary coolant distribution systems (e.g., connected to a FWS).

In each of the embodiments illustrated in FIGS. 1 to 3B an inventive apparatus 1A,1B,1C,1D may be positioned within (i.e., connected to) a secondary or side-stream cooling loop and may receive coolant (e.g., an enhanced glycol-water coolant mixture) that has been used to cool one or more components of a data center such as servers or the microelectronics within a server. Upon receiving the coolant the inventive apparatus 1A,1B,1C,1D applies nonthermal plasma to the coolant to eliminate or at least reduce bio-contaminants and other unwanted material that may be used by a bio-contaminant to grow or sustain itself.

Though each of the inventive apparatuses 1A,1B,1C,1D are illustrated as being positioned within a secondary or side-stream cooling loop this is merely exemplary. In yet additional embodiments each of the inventive apparatuses 1A, 1B,1C,1D may be connected inline.

Upon treating the coolant the inventive apparatus 1A,1B,1C,1D outputs a treated coolant to a heat exchanger, for example.

It should be noted that prior to being input into the apparatus 1A, 1B,1C,1D a coolant (e.g., an enhanced glycol-water coolant mixture) may be pre-filtered by one or more filtering means (not shown in Figures) to remove particulate matter before being exposed to plasma energy within the apparatus 1A, 1B,1C,1D in order to enhance treatment efficacy.

We now present a simplified description of the cooling configurations illustrated in FIGS. 1 to 3B.

Referring first to FIG. 1 there is illustrated a simplified Door Heat Exchanger cooling distribution configuration according to one or more embodiments of the disclosure. FIG. 1 can be used to illustrate both a Door Heat Exchanger and Rear Door Heat Exchanger configuration by simply changing the locations where the corrosion resistant piping 3a, 2ab that leads from, and to, the server rack 5aa is positioned. In a Door Heat Exchanger configuration the piping 2ab from the inventive apparatus 1A (e.g. a plasma disinfection system that includes an internal recirculation pump) that inputs liquid coolant (e.g., an enhanced glycol-water coolant mixture) into microelectronics 6aa to 6an (e.g., electronic servers, where “an” indicates a last microelectronics) of the server rack 5aa and the piping 3a that outputs the liquid coolant from microelectronics 6aa to 6an of the server rack 5aa into the inventive apparatus 1A may, respectively, be positioned at any position Pᵢ, and Pₒ, at the server rack 5aa while in a Rear Door Heat Exchanger configuration the corrosion resistant piping 2ab from the inventive apparatus 1A that inputs the liquid coolant into microelectronics 6aa to 6an of the server rack 5aa and the piping 3a that outputs the liquid coolant from microelectronics 6aa to 6an of the server rack 5aa into the inventive apparatus 1A may, respectively, be positioned Pᵢ, and Pₒ, at a rear door of the server rack 5aa.

In either configuration, water within a primary cooling loop (i.e., FWS) represented by corrosion resistant piping 1aa, 1ab and pump 1ac flows from one or more cooling towers 4 (hereafter “cooling tower”) to one or more heat exchangers 8a (hereafter “heat exchanger”). The heat exchanger 8a is configured to cool the water from the tower 4 within a primary cooling loop represented by piping 1aa, 1ab and pump 1ac as well as cool the coolant from the inventive apparatus 1A within a secondary or side-stream cooling loop represented at least by corrosion resistant piping 2aa, 2ab, 3a.

In an embodiment, the inventive apparatus 1A (as well as inventive apparatuses 1B,1C and 1D) may comprise a plasma disinfection system that applies nonthermal plasma (NTP) to the liquid coolant it receives within the secondary cooling loop in order to control contaminant growth in the received liquid coolant. In an embodiment, the plasma disinfection system may be further configured to generate reactive oxygen and nitrogen species upon application of the nonthermal plasma to the liquid coolant. Further, as described in more detail elsewhere herein, the plasma disinfection system may comprise one or more dielectric barrier discharge (DBD) electrodes configured to optimize energy efficiency.

In more detail, a controller 15 may be caused to dynamically adjust the power consumption of an inventive apparatus 1A,1B,1C,1D based on measured real-time cooling system parameters to maximize efficiency while ensuring optimal performance. The controller 15 or an inventive apparatus 1A,1B,1C,1D itself and associated sensors S_{T1} to S_{T4} monitors temperature parameters, including coolant inlet and outlet temperatures, ΔT (temperature differential), ambient temperature, and heat exchanger surface temperature to regulate the thermal efficiency. Flow parameters such as coolant flow rate, Reynolds number, pump speed, and chiller capacity utilization are also measured to help optimize circulation and heat dissipation. Electrochemical parameters, including oxidation-reduction potential (ORP), and PH levels are measured to ensure stable coolant chemistry and microbial control. The controller 15 or an inventive apparatus 1A,1B,1C,1D may also monitor plasma system parameters, such as plasma power level, duty cycle, electrode wear rate, gas composition (if applicable), and arc stability, in order to control and maintain adequate plasma discharges while minimizing energy. Energy consumption parameters like real-time power draw, energy efficiency ratio (EER/COP), and voltage/current levels are measured to allow for continuous power optimization. Finally, system health and maintenance parameters are measured to ensure long-term reliability of an inventive apparatus 1A,1B,1C,1D, including filter status, and predictive maintenance data. By measuring all of these parameters, the inventive apparatus 1A,1B,1C,1D dynamically regulates plasma power output, reducing unnecessary energy usage while maintaining and microbial control.

In accordance with embodiments, the combination of the controller 15 and associated sensors discussed herein and shown in the figures forms a plasma energy optimization that enhances efficiency and minimizes power consumption by, for example, helping to refine electrode design, dielectric properties, and discharge conditions.

In embodiments, the electrodes described elsewhere herein were selected so that they can be tailored to an application needs. For example, the electrodes discussed herein may take the form of a mesh electrode to improve gas flow and reduce power demand while solid electrodes may provide higher intensity with added cooling, Alternatively, the electrodes described herein may take the form of honeycomb electrodes having maximized surface area for uniform plasma discharge.

The dielectric materials used with some electrodes may have high permittivity, such as alumina and quartz, These materials were selected to lower ignition voltage and minimize energy losses. Further, the inventors designed the inventive electrodes herein after considering electrode spacing in order to optimize and balance discharge efficiency and to prevent arcing.

Operating conditions were dynamically controlled through power modulation, duty cycle adjustments, and real-time feedback on voltage, current, and temperature, ensuring minimal energy input while sustaining effective plasma generation.

In sum the inventive apparatuses 1A,1B,1C,1D are highly efficient plasma systems with reduced power consumption, enhanced uniformity, and improved operational stability across various applications.

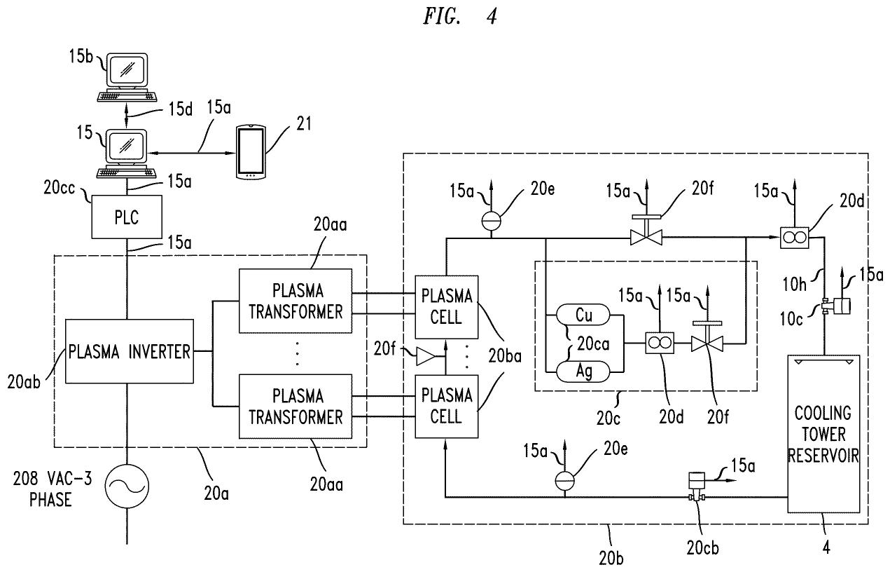

The inventive apparatus 1A (as well as inventive apparatuses 1B,1C and 1D) may also comprise an electronic controller (not shown in FIG. 1, but see component 15 in FIG. 4) and at least one memory storing instructions that, when executed by the at least one controller causes the controller to complete features and functions described elsewhere herein, including, but not limited to, controlling a time period that the nonthermal plasma is applied to the liquid coolant as well as the voltage and frequency of the applied nonthermal plasma.

In an embodiment, the plasma disinfection system may comprise a dual-stage nonthermal plasma chamber that generates and applies the nonthermal plasma to the liquid coolant to optimize exposure time in high-efficiency cooling loops. By “dual stage” the inventors mean two chambers of plasma cells that are configured in electrical series or in parallel. though “in series” gives a coolant more contact time with applied plasma while “in parallel” may increase the volume of coolant treated.

Still further, the inventive apparatus 1A (as well as inventive apparatuses 1B,1C and 1D) may still further comprise a catalytic neutralization unit 9a, 9b,9c,9d that removes residual oxidants before the liquid coolant is output (i.e., reenters) to the secondary cooling loop.

In embodiments, the application of nonthermal plasma to the liquid coolant is believed to generate hydroxyl radicals (OH), ozone (O₃), hydrogen peroxide (H₂O₂), and singlet oxygen (O₂) in the coolant which the inventors believe inactivates microbial contaminants and neutralizes excess oxidative species before being output (re-entering) the liquid cooling loop. In embodiments, a controller (not shown, but see component 15 in FIG. 4) may be configured to control the application of the nonthermal plasma to the coolant such that dosages is controlled such that the hydroxyl radicals, ozone, hydrogen peroxide and singlet oxygen comprise less than 0.05 ppm in the coolant.

To ensure the inventive apparatuses 1A,1B,1C,1D effectively reduces microbial contaminants, the controller 15 which comprises at least one memory storing executable instructions and associated sensors (pH S_{pH1} to S_{pH4}, ORP S_{ORP1} to S_{ORP4}, temperature S_{T1} to S_{T4}, biofilm, optical sensors, S_{b1} to S_{b4}) is configured to monitor key operational parameters of a liquid coolant, including: (i) pH, (ii) conductivity, (iii) real-time oxidation-reduction potential (ORP), and/or (iv) microbial load. Based on such monitored parameters, the controller 15 is caused to dynamically adjust the operation of the inventive 1A,1B,1C,1D in order to optimize microbial control. The controller 15 in combination with ORP sensors S_{ORP1} to S_{ORP4} in conjunction with selective catalytic decomposition/neutralization by a catalytic neutralization unit 9a, 9b,9c,9d regulates oxidative species levels and thresholds to ensure ORP levels remain within an optimal range of approximately 200-400 mV in order to suppress biofilm formation while preventing excessive oxidation of glycol and corrosion inhibitors. In an embodiment the controller 15 in combination with at least an ORP sensor S_{ORP1} to S_{ORP4} is caused to monitor the ORP level and compare it to a stored ORP threshold to ensure that the ORP level does not exceed approximately 450 mV which would pose a significant risk of coolant degradation due to increased oxidative conditions that accelerate the breakdown of glycol and corrosion-inhibiting compounds, potentially leading to system inefficiencies and material degradation. In such cases, the inventive apparatuses 1A,1B,1C,1D in combination with catalytic neutralization units 9a, 9b,9c,9d initiates selective catalytic decomposition to mitigate excessive oxidative degradation. Conversely, ORP levels below approximately 150 mV result in insufficient reactive oxygen and nitrogen species (RONS) concentrations, thereby reducing the system's capacity to prevent biofilm formation and increasing the risk of microbial proliferation. Accordingly the controller 15 and its associated ORP sensor(s) S_{ORP1} to S_{ORP4} measure the ORP level and compare it to a stored lower ORP threshold to ensure that the ORP level does not fall below 150 mV. In an embodiment, the controller 15 causes an adjustment in oxidative species levels within the coolant to ensure adequate biocidal activity.

Each of the inventive apparatuses and/or their controllers 15 may include or be connected to one or more ORP sensors S_{ORP1} to S_{ORP4}, a catalytic neutralization unit 9a, 9b,9c,9d in order to dynamically regulate oxidative species concentrations based on real-time feedback, ensuring a stable and effective microbial control strategy while preserving coolant integrity and glycol stability. Empirical experimental data confirm that maintaining ORP within the defined range optimally balances microbial inhibition and coolant preservation, preventing excessive oxidation while mitigating biofilm formation and microbial growth risks.

The inventive apparatus 1A (as well as apparatuses 1B,1C and 1D) may may be viewed as a self-regulating for applying nonthermal plasma to a liquid coolant to control contaminant growth because the controller 15 (or apparatus itself) may be connected via wired or wireless channels to one or more real-time microbial contamination sensors, biofilm sensors and/or optical/fluorescence sensors S_{b1} to S_{b4} that detect, among other things, data associated with (a) the presence or absence of planktonic and sessile microorganisms, (b) biofilm buildup and (c) continuous microbial activity within the liquid coolant of the secondary cooling loop. and exchange sensed data and control signals with the controller.

In embodiments, the microbial sensors may comprise ATP Bioluminescence Sensors (e.g., LuminUltra@) for real-time microbial load detection, the biofilm sensors may comprise a Sensorex® S272 and an optical/fluorescence sensors may comprise a BugLab® BE3000.

Further the apparatus 1A (as well as apparatuses 1B,1C and 1D) may comprise an automated plasma power regulation module 1ad (the others are 1bd, 1cd, and 1dd) for controlling the application of NTP to a coolant based on a detected microbial load and a quality of the liquid coolant.

In an embodiment, the controller 15 and its at least one memory may execute stored instructions that cause the electronic controller to control the plasma disinfection system in order to generate nonthermal plasma over a variable plasma duty cycle in order to reduce energy consumption while maintaining a microbial load of less than 10 CFU/ml, for example.

In each of the embodiments discussed herein it should be noted that the inventive controller may be equipped with wired or wireless means, such as wireless circuitry, for operating remotely from apparatus 1A,1B,1C,1D to control apparatus 1A,1B,1C,1D, among other components. If needed, the controllers discussed herein may be connected to an electronic communications bus for communicating electronic signals to one or more elements of an inventive apparatus 1A,1B,1C,1D using a network protocol comprising one of Modbus, BACnet or SNMP to name just a few exemplary protocols.

The inventive apparatus 14 (as well as apparatuses 18,10,10) may be used in a method that applies nonthermal plasma to an enhanced glycol-water coolant mixture used in the cooling loops of the data centers illustrated in FIGS. 1 to 38.

Some exemplary steps in such a method may be as follows: applying a controlled amount of nonthermal plasma (i.e., controlled by the controller 15 in FIG. 4) to an enhanced glycol-water coolant mixture (e.g., a propylene glycol (PG25) or ethylene glycol coolant); controlling a catalytic neutralization unit 9a, 9b,9c,9d to mitigate glycol oxidation by introducing antioxidants (BHT, TBHQ), metal chelators (EDTA, phosphonates), and corrosion inhibitors (molybdates, benzotriazole) into the glycol-water coolant mixture; maintaining a pH of the enhanced glycol-water coolant mixture within the range of 7.5-9.0 using the sensors and controller disclosed elsewhere herein; removing oxidative byproducts through a catalytic neutralization unit 9a, 9b,9c,9d; reducing biofilm growth within the glycol-water coolant mixture flowing to or through microcapillaries of microelectronics 6aa to 6an (e.g., servers, graphical processing units (GPUs)); and reducing biofilm growth within the glycol-water coolant mixture flowing in one or more cooling distribution loops, such as the secondary of side-stream loop 2aa,2ab,3a that includes one or more electronic servers 6aa to 6an.

As used herein the enhanced glycol-water coolant mixture may be composed of a propylene glycol based coolant such as a PG25 propylene glycol coolant, or, alternatively, may be composed of an ethylene glycol coolant.

Each of the apparatuses 1A,1B,10 and 1D may comprise a modular apparatus that applies nonthermal plasma to a liquid coolant to control contaminant growth within a closed-loop liquid cooling distribution system of a data center, where the closed loop in FIG. 1 is represented by piping 2aa, 2ab, 3a and those devices and apparatuses, such as inventive apparatus 1A, connected to such piping.

Such a modular apparatus 1A,1B,10,1D may comprise a plasma disinfection module connected to the closed-loop liquid cooling distribution system; a plasma energy optimization system that minimizes power consumption based on cooling system parameters, where the electrodes of the plasma disinfection module are composed of a corrosion-resistant material construction that prevents oxidative degradation of cooling infrastructure; a fail-safe monitoring system for plasma streamer discharge, coolant quality, and system health diagnostics.

In embodiments, the modular inventive apparatuses 1A,1B,1C and 1D may be skid-mounted unit for rapid deployment in a new or existing data center.

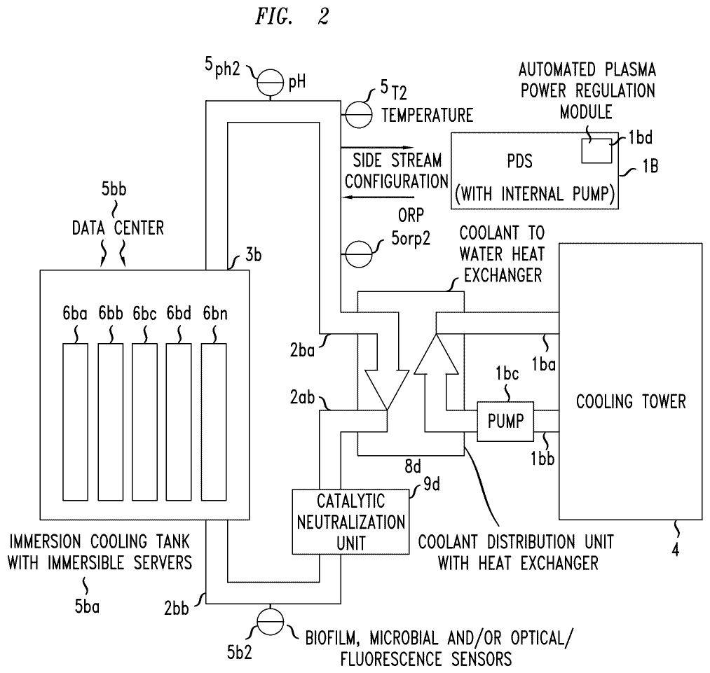

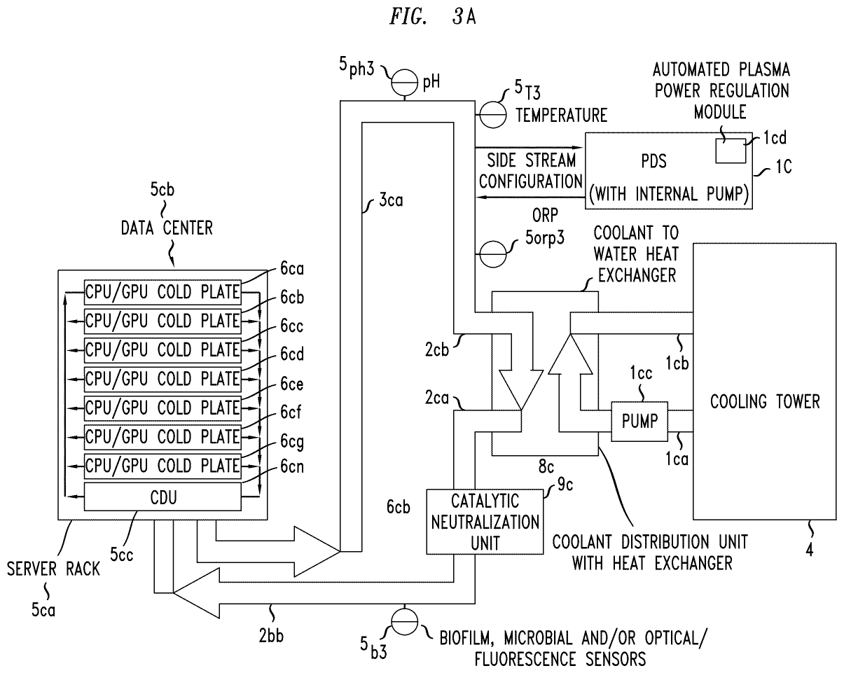

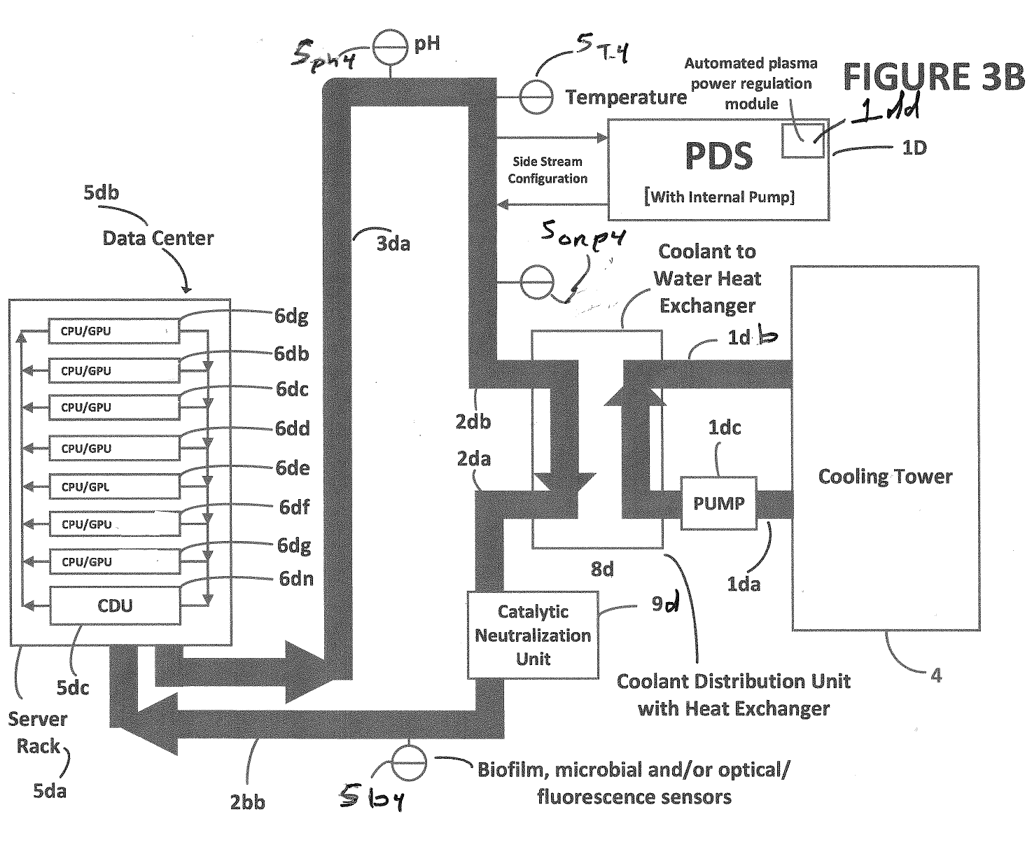

In embodiments, by “closed loop” is meant the secondary or side-stream cooling loops that are a part of: (i) a Door Heat Exchanger configuration, Rear Door Heat Exchanger (RDHx) configuration (FIG. 1); (ii) a Direct-to-Chip (D2C) system or a Direct Through Chip configuration (FIGS. 3A and 3B) and (iii) an Immersion Cooling configuration (FIG. 2).

Referring now to FIG. 2 there is illustrated a simplified of an Immersion Cooling configuration according to an embodiment of the disclosure.

Rather than repeat the details of the inventive apparatus 1B of FIG. 2, suffice it to say that all of the features set forth above with respect to inventive apparatus 1A apply, except as noted below.

Unlike the configurations in FIGS. 1, 3A and 3B in this configuration the microelectronics 6ba to 6bn (e.g., electronic servers, where “bn” indicates the last microelectronics) are immersed in a cooling tank or tanks 5ba (hereafter “tank”).

In addition, the heat exchanger 8b and a CDU may be combined with the CDU operable to separate a coolant from a primary distribution loop represented by piping 1ba, 1bb and pump 1bc (i.e., Facility Water System (FWS)) to a secondary cooling loop represented by piping 2ba, 2bb, 3b and devices and apparatuses connected to such piping, such as the inventive apparatus 1B. The combination of a CDU and heat exchanger 8b may also function to ensure that proper coolant pressures, coolant quality, coolant temperatures (e.g., above the dew point to minimize condensation risk), and coolant flows are maintained to each server 6ba to 6bn.

As noted previously, in an embodiment, the inventive apparatus 1B may comprise a plasma disinfection system that applies nonthermal plasma to the liquid coolant it receives within the secondary cooling loop in order to control contaminant growth in the received liquid coolant. In an embodiment, the plasma disinfection system may be further configured to generate reactive oxygen and nitrogen species upon application of the nonthermal plasma to the liquid coolant. Further, as described in more detail elsewhere herein, the plasma disinfection system may comprise one or more dielectric barrier discharge (DBD) electrodes configured to optimize energy efficiency.

In more detail, energy efficiency for electrodes within a cell may be optimized as follows.

First, the inventors selected electrode materials and configurations discussed elsewhere herein in order to minimize energy loss and maximize the effective plasma generation area. Additionally, the dielectric layers within a plasma cell, including its material and thickness, was considered critical in balancing breakdown voltage and energy transfer. Further, pulse modulation and power delivery were optimized in order to ensure that energy is used efficiently, while electrode spacing and plasma stability help maintain a consistent discharge without unnecessary power fluctuations.

Yet further, the inventive apparatuses 1A,1B,1C,1D include impedance matching circuitry between their respective power supplies and plasma cells to further reduce energy losses by ensuring that more energy is used in plasma generation rather than being reflected back. Finally, integrating proper heat management techniques, such as cooling systems, ensures that the generation of plasma occurs within optimal temperature ranges, reducing energy wasted as heat. By carefully considering all of these factors, the inventive apparatuses 1A, 1B,1C,1D achieve higher energy efficiency, making it more cost-effective and sustainable for industrial applications. In embodiments, electrodes composed of titanium (Ti) and/or Tungsten (W) with a Nickel/Platinum or SiC coating, and stainless steel are good examples of materials the inventors discovered optimize energy.

The inventive apparatus 1B may also comprise an electronic controller (not shown in FIG. 2, but see component 15 in FIG. 4) and at least one memory storing instructions that, when executed by the at least one controller causes the controller to complete features and functions described elsewhere herein, including, but not limited to, controlling a time period that the nonthermal plasma is applied to the liquid coolant as well as the voltage and frequency of the applied nonthermal plasma.

Again, the features and functions of the inventive apparatus 1B include the same components and capabilities as described previously above with respect to apparatus 1A and, thus, will not be repeated here.

Referring now to FIG. 3A there is illustrated a simplified of a Direct-to-Chip cooling configuration according to an embodiment of the disclosure. As before, rather than repeat the details of the inventive apparatuses 1A and 1B of, suffice it to say that all of the features set forth above with respect to inventive apparatuses 1A,1B apply, except as noted below.

Unlike the configurations in FIGS. 1 and 2 in this configuration the coolant is directed to microchannels within cold plates 9ca to 9cn (where “cn” indicates the last cold plate), where a cold plate may be connected to each microelectronic 6ca to 6cn (e.g., electronic servers, CPUs, GPUs where “cn” indicates the last microelectronic).

In addition, to distribute the coolant to each microchannel within each cold plate 9ca to 9cn the server rack 5ca may also comprise a CDU 5cc to separate the coolant from piping 2ca and distribute the coolant to each microchannel within a cold plate 9ca to 9cn. The CDU 5cc may also function to ensure that proper coolant pressures, coolant quality, coolant temperatures (e.g., above the dew point to minimize condensation risk), and coolant flows are maintained to each microchannels within a cold plate 9ca to 9cn as well as microelectronic 6ca to 6cn (e.g., CPU, GPU).

As noted previously, in an embodiment, the inventive apparatus 1C may comprise a plasma disinfection system that applies nonthermal plasma to the liquid coolant it receives within the secondary cooling loop in order to control contaminant growth in the received liquid coolant. In an embodiment, the plasma disinfection system may be further configured to generate reactive oxygen and nitrogen species upon application of the nonthermal plasma to the liquid coolant. Further, as described in more detail elsewhere herein, the plasma disinfection system may comprise one or more dielectric barrier discharge (DBD) electrodes configured to optimize energy efficiency. The inventive apparatus 1C may also comprise an electronic controller (not shown in FIG. 3A, but see component 15 in FIG. 4) and at least one memory storing instructions that, when executed by the at least one controller causes the controller to complete features and functions described elsewhere herein, including, but not limited to, controlling a time period that the nonthermal plasma is applied to the liquid coolant as well as the voltage and frequency of the applied nonthermal plasma.

Again, the features and functions of the inventive apparatus 1C include the same components and capabilities as described previously above with respect to apparatus 1A,1B and, thus, will not be repeated here.

It should be noted that the Direct-to-Chip configuration shown in FIG. 3A may also be combined with a Door Heat Exchange configuration where the piping 2ca,3ca may access a door (e.g., rear door) of a server rack, for example.

Referring now to FIG. 3B there is illustrated a simplified of a Direct-through-Chip cooling configuration according to an embodiment of the disclosure.

As before, rather than repeat the details of the inventive apparatuses 1A to 1C of, suffice it to say that all of the features set forth above with respect to inventive apparatuses 1A to 1C, except as noted below.

Unlike the configurations in FIGS. 1 to 3A in this configuration the coolant is directed to microchannels within each microelectronic 6da to 6dn without using a cold plate (where “dn” indicates the last microelectronic, CPUs, GPUs).

In addition, to distribute the coolant to each microchannel within each of the microelectronics 9da to 9dn the server rack 5da may also comprise a CDU 5dc to separate the coolant from piping 2da and distribute the coolant to each microchannels within each microelectronic 6da to 6dn. The CDU 5dc may also function to ensure that proper coolant pressures, coolant quality, coolant temperatures (e.g., above the dew point to minimize condensation risk), and coolant flows are maintained to each microchannel within each microelectronic 6da to 6dn.

As noted previously, in an embodiment, the inventive apparatus 1D may comprise a plasma disinfection system that applies nonthermal plasma to the liquid coolant it receives within the secondary cooling loop in order to control contaminant growth in the received liquid coolant. In an embodiment, the plasma disinfection system may be further configured to generate reactive oxygen and nitrogen species upon application of the nonthermal plasma to the liquid coolant. Further, as described in more detail elsewhere herein, the plasma disinfection system may comprise one or more dielectric barrier discharge (DBD) electrodes configured to optimize energy efficiency. The inventive apparatus 1D may also comprise an electronic controller (not shown in FIG. 3B, but see component 15 in FIG. 4) and at least one memory storing instructions that, when executed by the at least one controller causes the controller to complete features and functions described elsewhere herein, including, but not limited to, controlling a time period that the nonthermal plasma is applied to the liquid coolant as well as the voltage and frequency of the applied nonthermal plasma.

Again, the features and functions of the inventive apparatus 1D include the same components and capabilities as described previously above with respect to apparatus 1A to 1C and, thus, will not be repeated here.

It should be noted that the Direct-through-Chip configuration shown in FIG. 3B may also be combined with a Door Heat Exchange configuration where the piping 2da,3da may access a door (e.g., rear door) of a server rack, for example.

We now turn to a detailed discussion of the components within the inventive apparatuses 1A,1B,1C and 1D.

Upon receiving liquid coolant the inventive apparatus 1A,1B,1C,1D may be configured to direct the received, liquid coolant to components within the apparatus 1A, 1B,1C,1D as set forth in more detail in the '828 Application incorporated by reference herein.

For example, referring now to FIG. 4 the apparatus 1A,1B,1C,1D may comprise a plasma energy generation subsection 20a and a cell structure subsection 20b which together are operable to, among other things, generate and apply plasma energy to the coolant that has been received in order to form, among other things, reactive and molecular species in the coolant to treat unwanted material in the coolant (e.g., biological contaminants such as biofilm, Legionella and/or scale, biologically induced corrosion) as well as reduce the carbon footprint of the operation of a cooling tower.

Together the subsections 20a and 20b comprise components of a plasma disinfection system (PDS for short).

In embodiments, sections 20a and 20b generate and apply plasma energy in the form of full or partial discharges to control biological contaminants, including biofilm, Legionella and heterotrophic aerobic bacteria (HAB), among other unwanted materials.

In an embodiment, the exemplary apparatuses 1A,1B,1C,1D may reduce microbial concentration in the coolant to a level below 100 CFU/mL to ensure compliance with ASHRAE TC9.9 cooling water quality standards, for example. In an embodiment, the inventive apparatuses 1A,1B,1C,1D may be adapted to adjust a plasma intensity based on real-time microbial contamination levels automatically.

It should be noted that coolant flowing through an apparatus 1A, 1B,1C,1D may be pre-filtered to remove particulate matter before being exposed to plasma energy to enhance treatment efficacy.

As shown, subsection 20b may comprise one or more plasma cells 20ba and an electrolytic, biocidal treatment chamber 20c while subsection 20a may comprise one or more transformers 20aa and inverters 20ab. In an embodiment, each transformer 20aa may be connected to a separate cell 20ba and to an inverter 20ab. It should be noted that though only two cells 20ba are depicted in FIG. 4 this is merely exemplary and non-limiting. The number of cells may match the treatment parameters of a given application (e.g., 7 cells, 14 cells, 21 cells, etc.,) and may be configured within a single structure (e.g., enclosure).

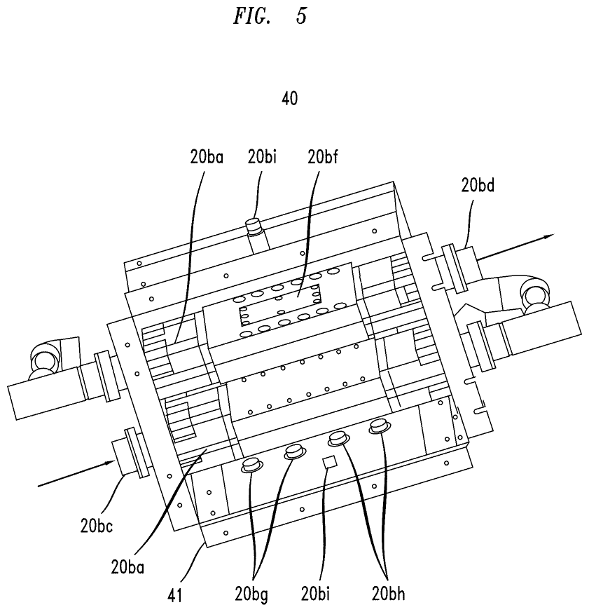

Referring now to FIG. 5 there is depicted an enlarged view of an exemplary plasma cell assembly 40 that may contain one or more plasma cells 20ba (one, two or more cells, i.e., multi-stages). In an embodiment, the received coolant may flow into fluid inlet 20bc where it may then be treated by cells 20ba within assembly 40. The so-treated coolant may then flow out of the assembly 40 via fluid outlet 20bd. In an embodiment, the assembly 40 may comprise an electromagnetic interference (EMI) shielded enclosure 41 configured to surround the cells 20ba and to prevent electromagnetic signals that are generated by the plasma cells 20ba within the enclosure 41 from emanating outside the enclosure. In one embodiment, the enclosure 41 may function to attenuate such signals at a level of 80 to 90 dB, for example. Further, each cell (or a group of cells) 20ba may be surrounded by a protective splashguard (not shown in FIG. 5). In an embodiment, the splashguard(s) function to protect the electronics within the enclosure 41 from being exposed to the coolant should one of the cells 20ba leak the coolant.

Electrical power may be provided to each of the cells 20ba via electrical conductors 20bh (only conductors connected to one cell 20ba are shown in FIG. 5, though similar conductors are connected to each cell 20ba). To prevent dangerous electromagnetic arching from occurring between the enclosure 41 and the conductors 20bh each of the conductors 20bh may be surrounded by one or more dielectric spacers 20bg (only spacers surrounding one conductors 20bh are shown in FIG. 5, though similar spacers may be used with each conductor).

Also shown in FIG. 5 are temperature sensors 20bi. In an embodiment, one sensor 20bi may be configured to detect the temperature of one cell 20ba, for example. In an embodiment, the sensor 20bi may comprise infrared (IR) sensors that function to detect a wide range of temperatures, e.g., 0 to °1000 F. In an embodiment, if the sensor 20bi detects a temperature that approaches 60° C. (140° F.) then the apparatus 1A, 1B,1C,1D (e.g., controller 15 and/or test set 21 (e.g., hand-held mobile device with an APP)) may be operable to remove the power being supplied to the cell(s) 20ba, in effect shutting it (them) off.

In the embodiments depicted in FIGS. 4 and 5 the cells 20ba are configured in series where coolant flows through an inlet (e.g., inlet 20bc) into a first cell 20ba and is treated, and then is fed by piping (not shown in figures) into additional cells 20ba for additional treatment before exiting via outlet 20bd. It should be understood, however, that inventive cells may be configured in series or in parallel the details and configurations of which are set forth in detail in the '503 Application incorporated by reference herein or in a parallel-series configuration.

In an embodiment, each of the cells 20ba may comprise a plurality of cascaded, single slot double dielectric barrier discharge (DDBD) electrodes, or alternatively, a number of cascaded, single planar dielectric barrier discharge (DBD) electrodes. The number of each type of electrode that can be cascaded and contained within a cell 20ba may depend on the mass flow rate of the particular industrial application, for example. In an embodiment, between each DDBD electrode may be configured a glass filled polyoxymethylene (commonly referred to as Delrin®) spacer, for example where the plurality of DDBD electrodes and spacers may be fastened or otherwise connected together using compression fittings.

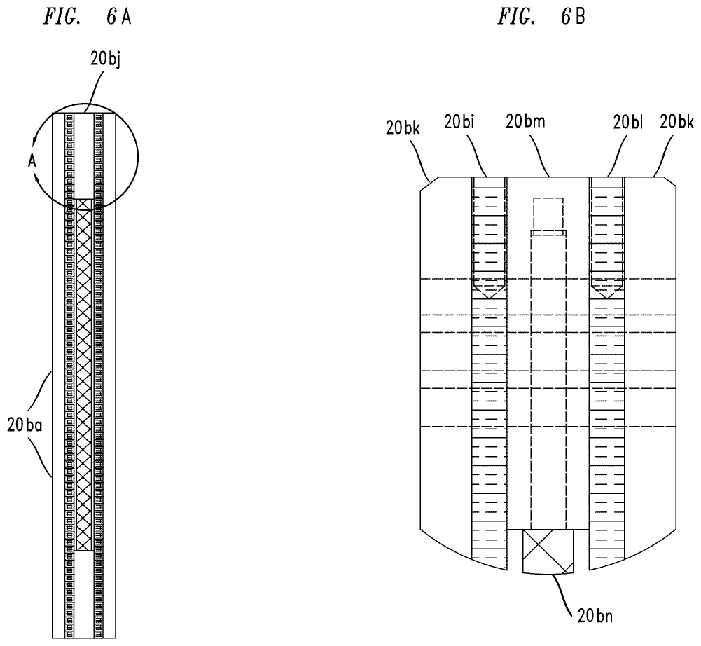

Referring now to FIGS. 6A and 6B there is depicted exemplary sections of an exemplary DDBD plasma cell 20ba. As depicted each cell 20ba may comprise a slot structure 20bj (see enlarged section “A” in FIG. 6B) that in turn may comprise at least two negative cathode electrodes 20bk, Mica isolation section (e.g., sheet, plate) 20bl, slotted Mica laminate fitting 20bm and a positive anode electrode 20bn.

As coolant flows between the channel (e.g., 2-to 4-millimeter channel) between the anode electrode 20bn and each cathode electrode 20bk, the coolant may be subjected to plasma energy applied by the electrode configuration. As a result, high electric fields, shock, ultraviolet light, and heat from plasma streamers denatures unwanted material (e.g., biological contaminants). Furthermore, the plasma streamers produce reactive oxygen species, hydrogen ions that react with water molecules to form hydrogen peroxide, ozone, and dissolved oxygen to treat (eliminate or substantially reduce) harmful and unwanted material (e.g., biological contaminants such as biofilm, Legionella, etc.) and reduce biologically induced corrosion. In embodiments, the plasma energy may comprise partial and full discharges.

As understood by those skilled in the art, a type of discharge known as a streamer or filamentary discharge is a type of transient electrical discharge. Streamer discharges (“streamers” for short) can form when an insulating medium (for example air molecules in the water) is exposed to a large potential difference. For example, when the electric field created by an applied voltage from a cell 20ba is sufficiently large, accelerated electrons strike air molecules in the mixture with enough energy to knock other electrons off them, ionizing them. The freed electrons go on to strike more molecules in a chain reaction. These electron avalanches (i.e., Townsend discharges) create ionized, electrically conductive regions in air gaps or bubbles near an electrode creating the electric field. The space charge created by the electron avalanches gives rise to an additional electric field. This field can enhance the growth of new avalanches in a particular direction, allowing the ionized region to grow quickly in that direction, forming a finger-like discharge—i.e., a streamer.

Streamers are transient (exist only for a short time) and filamentary, which makes them different from corona discharges. As used herein the phrase “streamer” may be used synonymously with the phrase “partial discharge” to distinguish such discharges from full discharges.

The application of plasma energy to the coolant in the channel between an anode electrode 20bn and each cathode electrode 20bk may first cause a streamer and then an arc to form in the coolant. That is to say, an ionized path created by streamers may be heated by a large current, thus forming an arc. To prevent such arcs (i.e., arcing across slots), a Mica fitting 20bm may be included that functions to separate each slot from one another. Further, spacers may be included in a cell 20ba that function to electrically isolate the cascaded slots from an outer housing that encloses one or more cells 20ba (not shown in FIGS. 6A and 6B).

In an embodiment, a gas distribution system (not shown in FIGS. 6A and 6B) may inject air into the top and bottom of each slot through the Mica fitting 20bm. The introduction of compressed air functions to increase ozone generation in the water between electrodes.

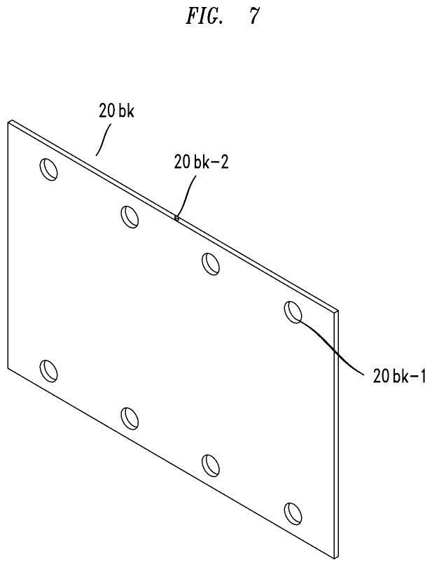

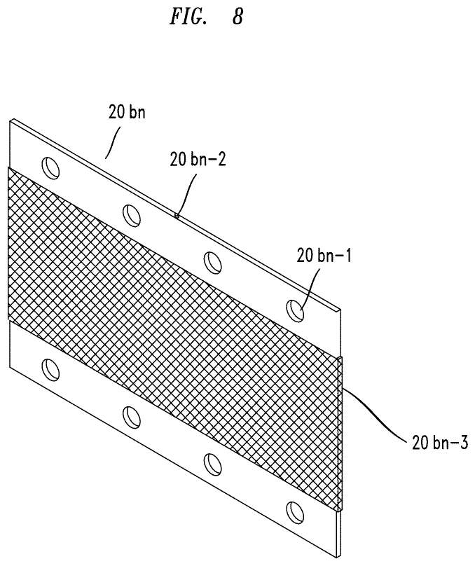

Referring now to FIGS. 7 and 8 there are depicted exemplary configurations of an exemplary, inventive cathode and anode electrodes 20bk, 20bn. In embodiments, the electrodes may either be non-porous or comprise porous, aluminum oxide plasma sprayed stainless steel 316L plates. When plain electrodes are used, the electrodes may be coated to increase their conductivity, and to decrease the voltage necessary to generate streamers in the coolant.

In one embodiment the electrodes (anode 20bn and cathode 20bk) may comprise planar electrodes made from a 316L stainless steel. An exemplary anode electrode may have the dimensions of 280 mm by 180 mm by 1 mm thickness and may be coated with a 5-micron Aluminum Oxide AL2O3 layer that has a 5% porosity, a permittivity (εr) of 8-10, and conductivity (σ) of 2 μS/cm. Exemplary cathode electrodes may have dimensions of 280 mm by 180 mm and may be laminated with 280 mm by 180 mm by 1 mm thickness (length versus width versus thickness) Mica sheets, such as sheets 20bl. The Mica sheets 20bl may be configured to function as dielectric barriers and may have a permittivity (εr) of 8-10.

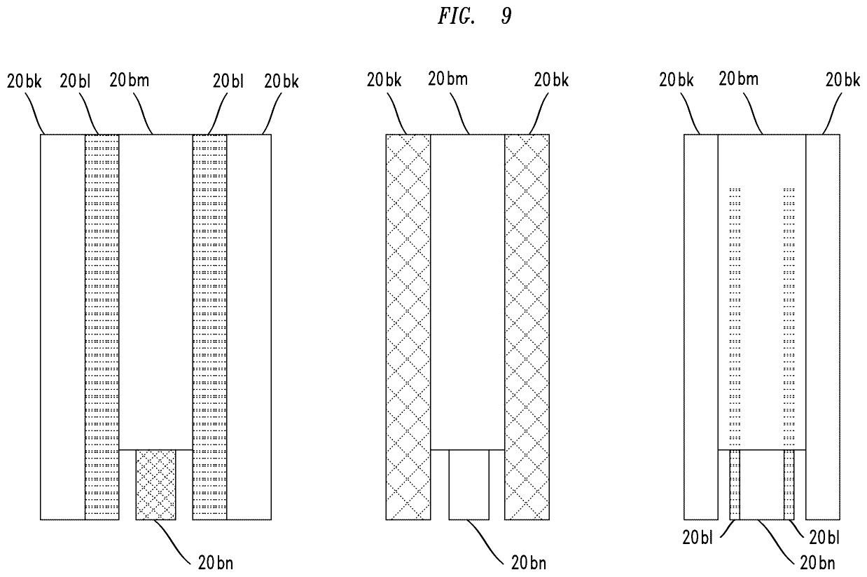

Referring now to FIG. 9 there is depicted alternative electrode configurations according to embodiments. As shown, one configuration (labelled “VAR I”) may comprise a DDBD electrode with Mica sheets 20bl between the anode 20bn (e.g., a porous plasma sprayed anode plate) and cathode electrodes 20bk. Another configuration (labelled “VAR II”) may comprise a DBD electrode with porous plasma sprayed cathode electrodes 20bn, and a non-porous stainless steel 316L anode electrode 20bk, while yet a third configuration (“VAR III”) comprises a DBD electrode with Mica sheets 20bl adjacent a non-porous anode electrode 20bk and a non-porous stainless steel 316L cathode 20bn.a pair of electrodes 20bk,20bn may be used by the electrodes 20bk,20bn to generate extremely high electric field strengths (E) in the order of 150 kV/cm at atmospheric pressure with electron densities between 1014/cm³ and 1015/cm³, and a current density, J, between 75 A/cm² and 225 A/cm², where the current density is based on the product of the electric field strength and the complex conductivity (o) of the mixture between electrodes and Mica fittings 20bm, namely:

J=σE

In embodiments, the generation of electric fields with such high electric field strengths creates the before-mentioned streamers in the coolant in the channel between an anode and its adjacent or corresponding cathode electrode.

As noted previously, exemplary electrodes may be coated or otherwise include either a layer (i.e., sheet) of aluminum oxide or Mica laminate on their surface. In embodiments, either type of layer may function to redistribute an electric field during a plasma energy pre-discharge phase. In addition, in embodiments where the relative permittivity and conductivity of the coolant in the channel between two dielectrics is decreased, the electric field strength on the surfaces of the electrodes may increase. Increasing the electric field strength produces larger amounts of streamers which results in improved rotational and vibrational excitation, electron avalanche, dissociation, and ionization processes.

Referring now to FIGS. 10A to 10E there are depicted views of another exemplary plasma cell 200 which may be used as cell 20ba as well for example.

In FIG. 10A the cell 200 is shown connected to first and second manifolds 201a, 201b. FIG. 10B is a cross-sectional view taken at section A-A in FIG. 10A while FIG. 10C is an enlarged view of a section of cell 200 (view “B”) that depicts exemplary layers of cell 200.

Referring to FIG. 10C, the exemplary cell 200 may include a main body layer 200a, negative electrode layer 200ba, fluid channel layer 200c where coolant, for example, may flow, a first dielectric insulating layer 200d, first and second sealant layers 200e, 200f, positive electrode layer 200g, protective spacer layer 200h, a second dielectric insulating layer 200i, a transparent window layer 200j and a cover layer 200k.

In an embodiment the transparent window layer 200j may allow a user or imaging device to view plasma streamers, for example, generated by the plasma cell 200.

In embodiments, the main body layer 200a may be composed of a plastic (e.g., Ultem 1000), the protective spacer layer 200h may be composed of a plastic (e.g., Ultem 1000), the transparent window layer 200j may be composed of an acrylic, the negative electrode layer 200b may be composed of stainless steel, the positive electrode layer 200g may be configured as a mesh layer and may be composed of a stainless steel, the first and second dielectric insulating layers 200d, 200i may be composed of a quartz, and the sealant layers 200e,200f may be configured as gasket(s) and may be composed of a rubber (e.g., a synthetic rubber and fluoropolymer elastomer, such as Viton®).

The inventors discovered that during assembly of an exemplary plasma cell, forces (pressures) applied to join the layers together may result in cracks in the insulating layers 200d, 200i. To reduce the chances of such cracking the inventors include the spacer layer 200h which is configured between the insulating layers 200d, 200i to absorb the forces applied during assembly in order reduce the chances that the insulating layers 200d,200i will crack.

Further, in embodiments the first gasket layer 200e may be configured around the edges of adjacent layers to prevent or reduce leakage of a liquid (e.g., coolant between electrodes) into other layers of the cell 200 while the second gasket layer 200f may also be configured around the edges of adjacent layers to prevent or reduce leakage of a liquid (e.g., coolant) into the other layers of the cell 200 (e.g., into the electrode layer 200b).

The structure described above may be incorporated into a DDBD electrode 207 (FIG. 10D) or DBD electrode 208 (FIG. 10E).

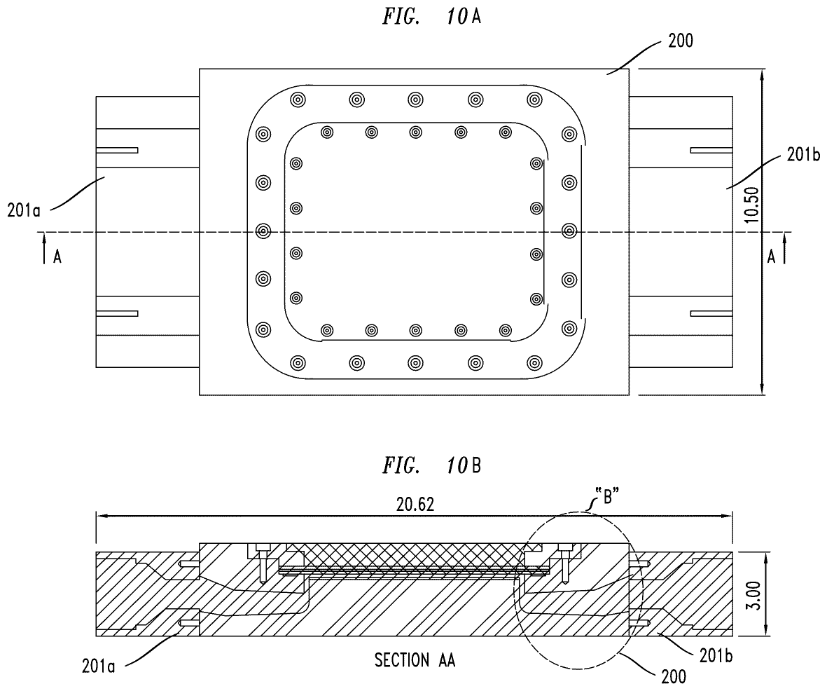

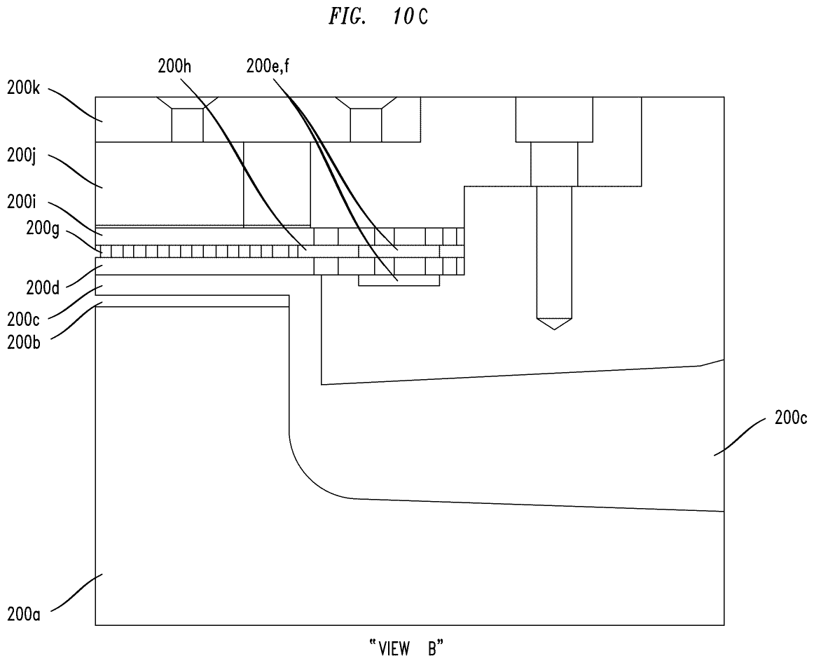

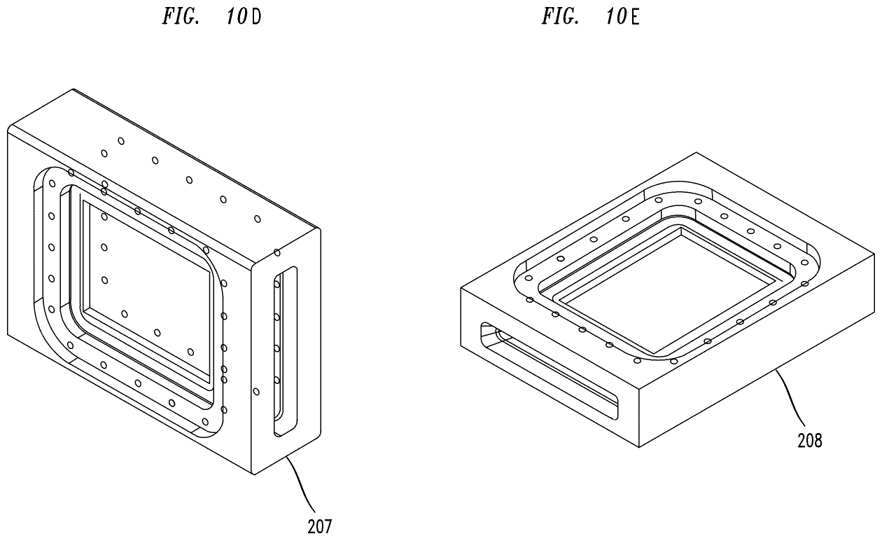

Referring now to FIG. 11A there is depicted an enlarged view of an exemplary manifold 201 (e.g., 201a or 201b in FIGS. 10A or 10B) that may be configured (i.e., connected) to each of the one or more plasma cells to allow coolant to pass through into the fluid channel layer of respective plasma cell.

In an embodiment, the manifold 201 may comprise a main body 202 that may be composed of an acetal-based plastic (e.g., Delrin® plastic). In an embodiment, the main body 202 may comprise a passageway 203 configured to allow a liquid (e.g., coolant) to pass through into the fluid channel layer of a plasma cell 20ba, 200, for example. The passageway 203 comprises an opening 204 on either end (only one opening 204 is shown in FIG. 11A), where one opening receives the coolant and directs the coolant to the passageway 203 and the other opening may discharge the coolant from the passageway 203 to the fluid channel layer of a plasma cell.

The main body 202 may additionally comprise one or more (typically more) connection passageways 205 and corresponding openings 206 configured to receive a fastener (e.g., bolt, screw) to name just one of the many ways that manifold 201 may be connected to a cell. In an embodiment, to connect a manifold 201 to a plasma cell, a respective fastener may be inserted into and received by an opening 206 of the manifold, pass through a corresponding passageway 205 and make contact with a plasma cell.

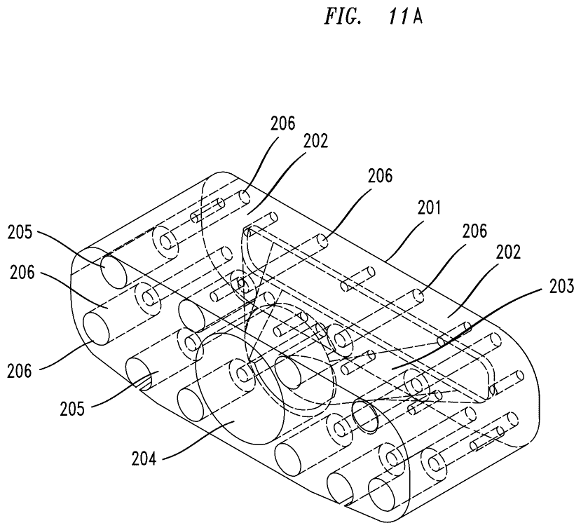

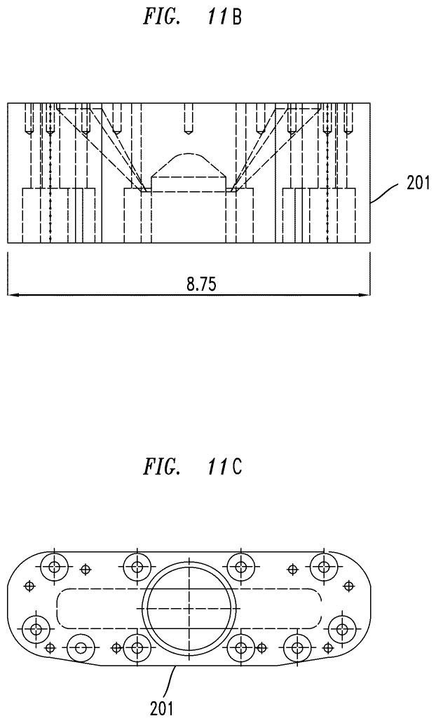

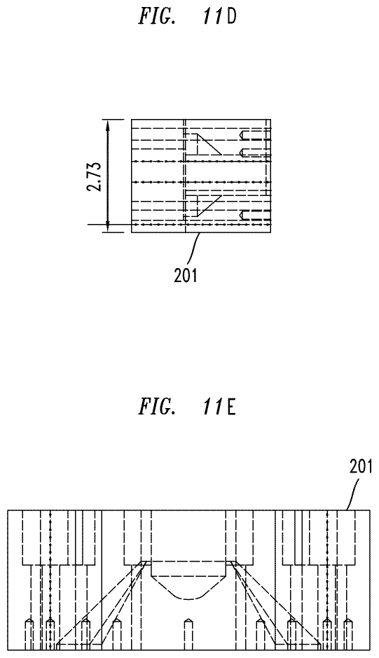

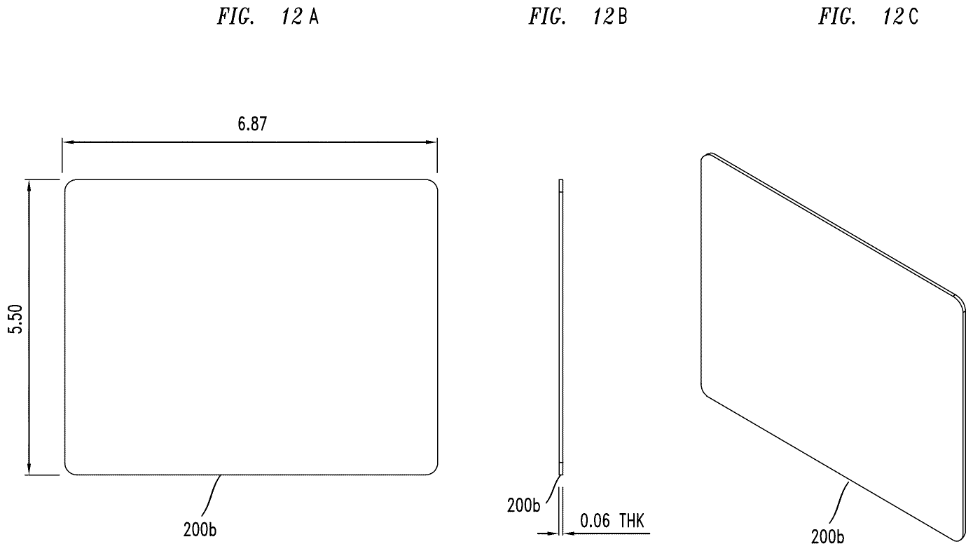

FIGS. 11B to 11E depict exemplary dimensions and a configuration of the exemplary manifold 201, while FIGS. 12A to 12C depict exemplary dimensions and a configuration of an exemplary negative electrode layer 200b and FIGS. 13A to 13C depict exemplary dimensions and a configuration of an exemplary positive electrode layer 200g, though it should be understood that such configurations and dimensions are merely exemplary and non-limiting.

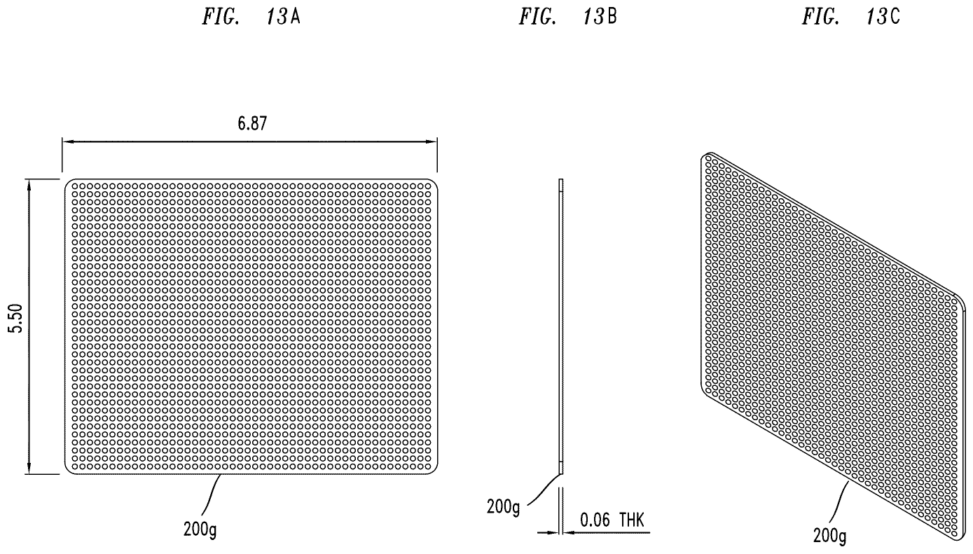

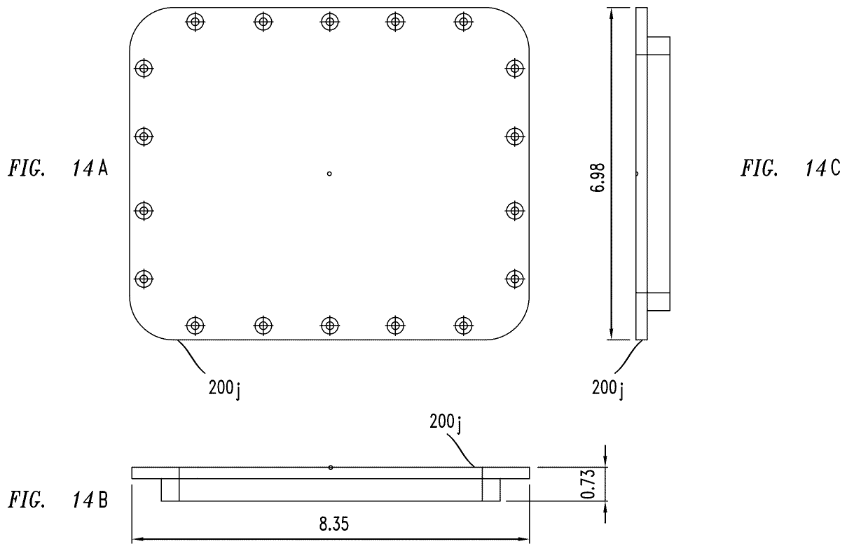

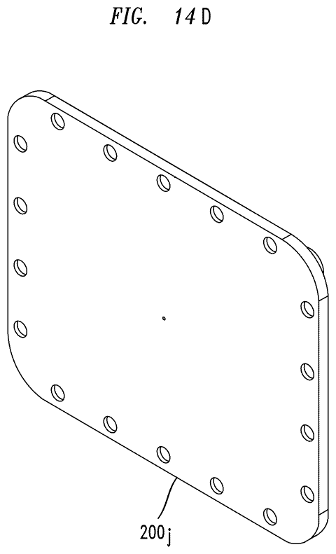

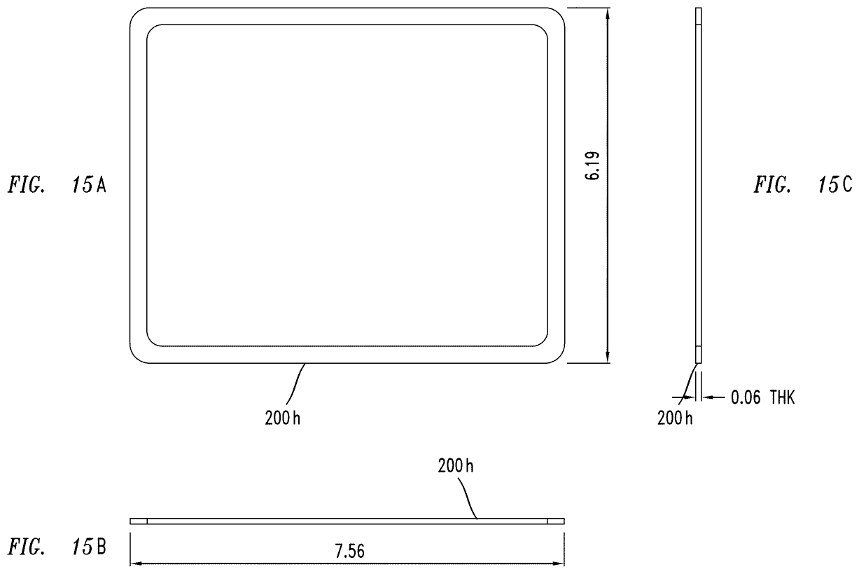

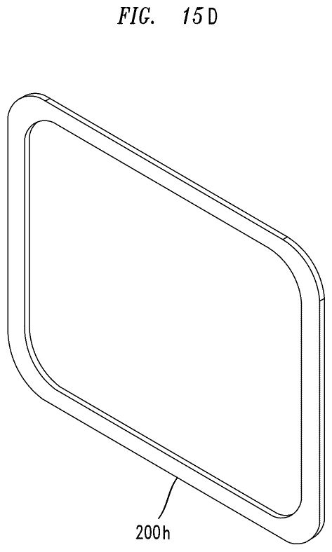

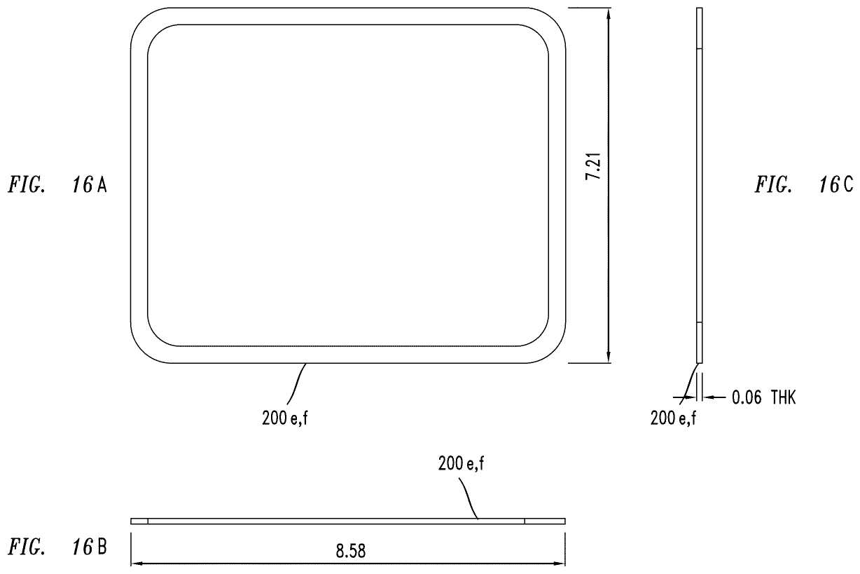

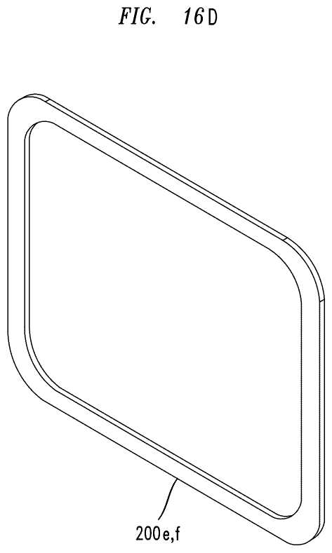

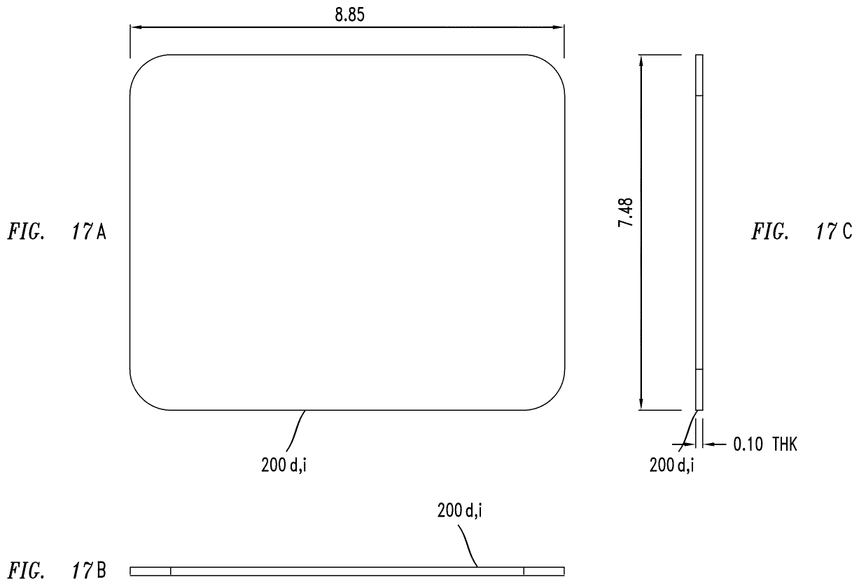

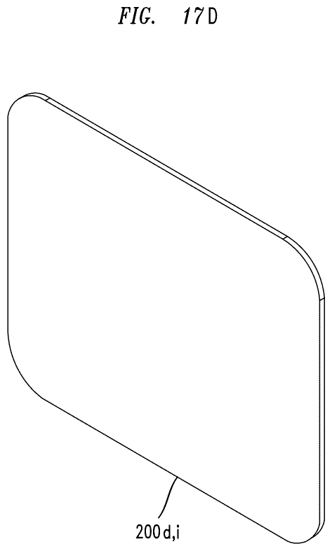

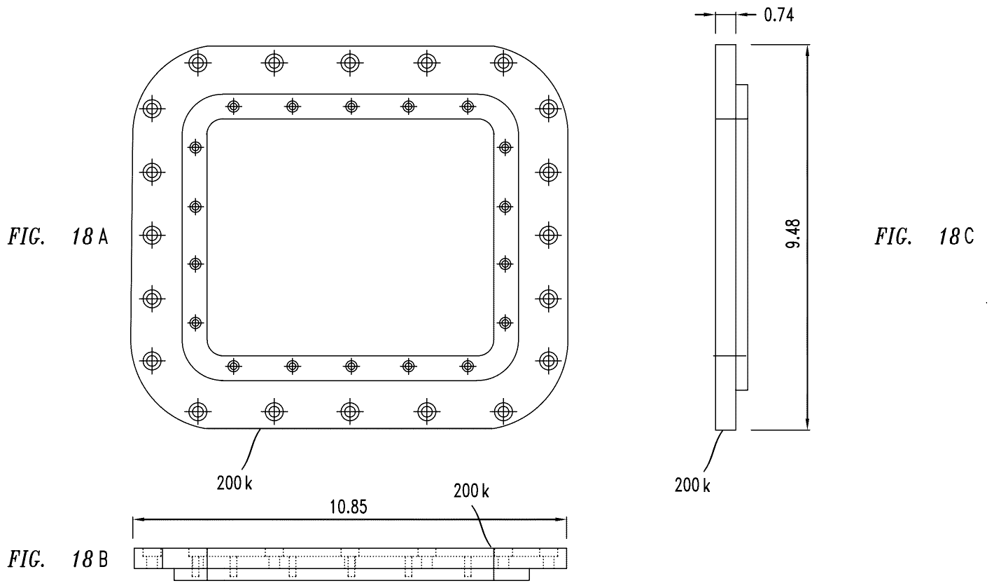

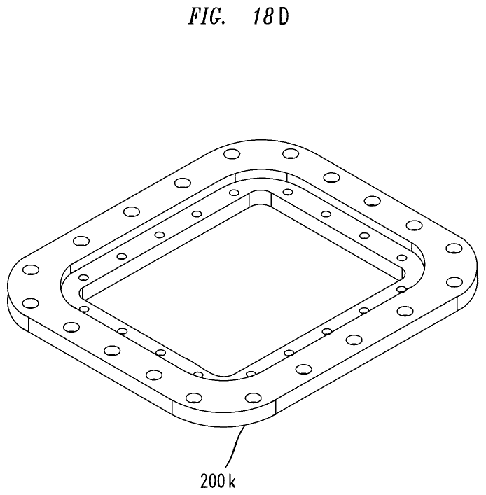

Similarly, FIGS. 14A to 14D depict exemplary dimensions and a configuration of an exemplary transparent window layer 200j, FIGS. 15A to 15D depict exemplary dimensions and a configuration of an exemplary protective spacer layer 200h, FIGS. 16A to 16D depict exemplary dimensions and a configuration of an exemplary sealant layer(s) 200e,200f, FIGS. 17A to 17D depict exemplary dimensions of exemplary dielectric layer(s) 200d,200i and FIGS. 18A to 18D depict exemplary dimensions of exemplary cover layer 200k though it should be understood that such dimensions are merely exemplary and non-limiting.

Referring back to FIG. 4, to provide energy to the plasma cells 20ba, (or 200) the plasma transformers 20aa and inverters 20ab (sometimes collectively referred to as “generator”) may comprise structure as described in the '965 Application (see FIG. 6 of that application) assigned to the same assignee as the present application which is incorporated by reference herein as if set forth in full herein. One exemplary structure may comprise a 10 KW a unipolar/bipolar device with an automatic operating pulse density modulation (PDM) frequency range from 1 kHz to 30 KHz. Further, the plasma generator may be operable to tune an output frequency to maximize the peak voltage and maintain the breakdown voltage in the plasma discharges it generates in the coolant. The plasma generator may be connected to a 208 VAC 3-phase electrical utility source via a 3-phase electrical power cable and operable to produce signals having a 30 kV output voltage and a 0.167 A current, for example, in order to supply each of the a plasma cells 20ba (or 200) with the energy required to allow a cell to produce high-energy electric fields (electrohydraulic discharges) in a coolant. The plasma generator may be configured such that it is installed in an electronic housing unit along with plasma cells 20ba (or 200), for example, or may be installed in separate housing with the necessary connections to cells. It should be understood that by configuring the generator in the housing, the generator may be connected to plasma cells using short (dimension-wise) connections. This configuration aids in insuring that those users of the apparatus 4 are not exposed to the high voltages produced by the plasma generator and makes the supply of energy to the cell more efficient (i.e., the shorter the physical connection, the less energy is lost through the connecting cables, wires, etc.).

In an embodiment, the voltage and frequency being applied to the plasma cells 20ba (or 200) may be controlled by a controller 15 or the PLCs 20cc as described in more detail in the '503 Application (see FIG. 5 of the '503 Application) to, among other things, insure that the thermal stresses (e.g., temperatures) generated as the cells 20ba (or 200) operate do not result in a degradation of the structure of the cells 20ba. For example, if temperatures within a cell 20ba exceed a maximum, threshold temperature (e.g., approaching 1000° F.) for too long a period of time or sudden spikes in temperature occur the internal components and the material composition of such components of a cell 20ba (e.g., glues holding elements of a cell 20ba together) may degrade. Such a degradation may result in a cell becoming less efficient or completely failing, for example.

Yet further, because the conductivity of the coolant flowing between electrodes of cells 20ba (or 200) may change over time the controller 15 and components of pulse width modulator/pulse density (PWM/PDM) circuitry described in more detail in the '503 application may be operable to adjust the “on” and “off” times (duty cycle) to make sure a resonant frequency is maintained.

Further, the voltage and frequency of the signals generated by a plasma generator to each of the cells 20ba (or 200) may be controlled (e.g., adjusted if necessary) such that each of the cells operates at a frequency that provides a maximum peak-to-peak voltage at the lowest amount of power (i.e., a resonance frequency).

In an embodiment, the plasma generator may include the following sub-circuitries, circuitry, and/or modules: AC to DC bus-bar voltage/current circuitry, IGBT (Insulated Gate Bipolar Transistor) module, microcontroller (which may be separate from, or the same as controller 15), status LEDs, pulse width modulator/pulse density modulation section, gate driver opto-couplers, fault detection and protection circuitry, AC-to-DC low voltage converters, a high voltage output pulse transformer and tesla load tuning coil, and thermal management circuitry, the details of which are described in the '503 Application that has been incorporated by reference herein in its entirety.

In an embodiment, flow meters (not shown in figures) may be configured to measure the level of the coolant flowing into the cell(s) 20ba (or 200) to insure that a sufficient amount of the coolant is indeed flowing so that when the cells generate plasma streamers the streamers are discharged in the coolant, and not into air. A more detailed description of the function and features of the flow meters is set forth in the '503 Application which has been incorporated by reference herein in its entirety.

In embodiments, sensors 20e may be configured to adaptively control the temperatures and pressures being exerted on electrodes that make up plasma cells 20ba (or 200) due to the changes in backpressures, for example, that build up due to changes in the flow of water fully explained in the '503 Application as well.

As noted previously, subsection 20b may also comprise an electrolytic, biocidal treatment chamber 20c that comprises one or more biocidal electrodes 20ca, one or more internal pumps 20cb, and one or more PLCs 20cc. In embodiments, the functions completed by the PLCs 20cc may alternatively, or additionally, be completed by controller or by a specialized computer 15b located at a remote location (i.e., not co-located) or may be partially completed by PLCs 20cc, or by test set 21 (e.g., hand-held mobile device with an APP) or partially by controller 15. partially by the specialized computer 15b located at a remote location that is connected to the PLCs 20cc and/or controller 15 or components/elements of apparatuses 1A,1B,1C via a wired, wireless or some combination of the two via communications channel 15d, for example.

Further, the inventors believe that while deleterious bacteria, such as biofilm and Legionella, may flow through the piping of a heat transfer system, some bacteria may be retained on the surfaces of such a system (e.g., on the surface of a cooling tower heat exchanger). Thus, such bacteria may not be carried in the coolant that flows into the inventive apparatus 1A,1B,1C,1D to be treated by the plasma cells. However, such bacteria may be effectively treated by biocidal ions generated by the biocidal electrodes. For example, in an embodiment, biocidal ions generated by electrodes 20ca may be output by inventive apparatus 1A,1B,1C,1D and then flow to the surfaces of a cooling tower heat exchanger to treat such bacteria.

In more detail, the inventors believe that biocidal copper and silver ions may effectively treat bacteria and biofilm (e.g., both planktonic and sessile bacteria). In more detail, positively charged copper ions are believed to react with negatively charged ions on the cell wall of such bacteria, thereby damaging the integrity of the cell membrane and allowing the silver ions bind to the cellular protein (DNA and RNA) and the respiratory enzymes to destroy the bacteria, for example.

Backtracking somewhat, to generate the biocidal ions coolant may flow between each biocidal electrode 20ca. An electrode 20ca may include one or more positively charged anodes and negatively charged cathodes (collectively “electrodes”). In embodiments, each of the electrodes 20ca may be composed of one or more of the following, non-limiting exemplary materials: arsenic, antimony, cadmium, chromium, copper, mercury, nickel, lead, silver, and zinc, for example. In embodiments, reactions (described in more detail herein) may cause the composition of the elements (e.g., copper, silver) to be “sacrificed” (i.e., released into the coolant) to control sessile bacteria, for example.

In an embodiment, a DC power supply (not shown in FIG. 4) may be operable to supply the electrodes 20ca with a variable amount of DC power. Upon receiving such power, the biocidal electrodes 20ca may be operable to form an amount of ionized, dissolved metal ions (e.g., biocidal ions, copper and silver) in the coolant depending on the magnitude of the DC current supplied to the electrodes 20ca and upon the flow rate of the coolant through the electrodes 20ca.

Controller 15 may be operable to control the DC power supply by exchanging control signals with the supply, for example, such that the voltage and corresponding current generated by the supply may vary (i.e., a variable voltage and/or current).

Switches (not shown; e.g., electrical, electronic, microelectronic) may be included that may be operable to (i.e., function to) reverse the polarity of the biocidal electrodes 20ca, and can be controlled by controller 15 (or PLCs 20cc) via an RS485 bus, or Internet of Things (IOT) bus 15d, for example. In embodiments, biocidal ions released into the coolant function to inactive bacterial contaminants (e.g., biofilm, Legionella) in the coolant.

In more detail, the controller 15 (or PLCs 20cc) may be operable to send control signals to switches or relays known in the art (not shown in the figures) to reverse or change the polarity of electrodes 20ca from positive to negative, and negative to positive. For example, upon receiving such control signals the switches/relays may be operable to connect a negative or positive voltage to a respective biocidal electrode 20ca. In accordance with principles of the invention, by alternating the polarity of the electrodes 20ca the leaching of ions from the electrodes may be controlled.

The polarity of each biocidal electrode 20ca determines whether ions will leach from, or to, an electrode. For example, when the polarity is positive at a first electrode and negative at a second electrode then ions may leach from the first electrode. Conversely, when the polarity of the first electrode is negative and the polarity of the second electrode is positive, ions will leach from the second electrode. The ability to control the polarity of the biocidal electrodes 20ca, therefore, also allows the controller 15 to effectively control the leaching of ions (e.g., metal ions) from one electrode to another via, and to, the coolant there between. Relatedly, the ability to control the leaching of ions from the biocidal electrodes 20ca further allows the controller 15 to minimize the build-up of ionic material on the cathodic electrode (i.e., the electrode that ions flow to after having leached from an opposite electrode). Said another way, to avoid too much build-up of ionic material on one electrode, the controller 15 may be operable to change the polarity of the biocidal electrodes 20ca to reverse their polarity, and therefore reverse the flow of ionic material (and related build-up) from one electrode to another.

The transfer of material may be controlled by controlling the voltage applied to the electrodes 20ca. For example, for a given amount of energy within a given voltage (i.e., a DC electric charge), the mass (amount) of the material leached from an electrode is directly proportional to the equivalent weight of the electrode's material and can be computed using Faraday's second law of electrolysis:

$$m = ( \frac{Q}{F} ) ( \frac{M}{z} )$$

where (m) is the mass of the material liberated at an electrode, (Q) is the total electric charge passed through the material, (F) is Faraday's constant, (M) is the molar mass of the material, and (z) is the valency number of ions of the material. The following exemplary chemical reactions represent the release of biocidal ions from an electrode composed of an alloy of both silver and copper for example, through electrolytic ionization:

Cu→Cu²⁺+2e⁻

2Ag→2A^{g+}+2e⁻

In an embodiment, exemplary silver and copper alloy-based biocidal electrodes 20ca may be composed of a variable amount of silver and copper. For example, the range of silver-to-copper may be a minimum of 60:40 silver to copper while a maximum may be 80:20. As material (cupric and silver ions) are released from an electrode (i.e., leached), their release causes the electrode to be gradually consumed. Further, it is believed that once the cation ions (cations for short) have been released into the coolant, the cations react with negatively charged portions of bacteria in the coolant (e.g., cell walls of the bacteria) to form electrostatic bonds. The energy (force) associated with the formation of the bonds is believed to lead to the distortion of the cell wall of the bacteria (i.e., the walls become more permeable and eventually breakdown, causing cell lysis and cell death). For example, a positively charged cation will attract a negatively charged ion that comprises an integral portion of the cell wall. As a result of the attractive force, the negatively charged ion will feel a force that is pulling it away from the surrounding cell wall, leading to a weakness and even breakdown of the cell wall. In an embodiment, this process may be simultaneously felt by a plurality of negatively charged ions making up the cell wall, leading to an overall weakness and breakdown of the cell wall. Once the cell wall is effectively weakened or broken down, the bacteria or biofilm becomes substantially weakened or even destroyed.

The plasma disinfectant system 20 may further include flowmeters 20d (e.g., magnetic flow meters). In an embodiment, the flowmeters 20d may be configured or positioned to determine the rate that the coolant flows into the chamber 20c surrounding the electrodes 20ca. In an embodiment, the determined flow rate may be sent to the controller 15 via a wired or wireless connection in the form of one or more electronic signals. Thereafter, the controller 15 may be operable to compute both an instantaneous and averaged concentration of dissolved ions based on the received signals, and, thereafter, may be operable to control the power up or down (voltage) that a DC power supply (not shown in figures) is supplying to the biocidal electrodes 20ca. In an embodiment, a higher power may result in a greater leaching of metal ions into the coolant which, in turn, has the effect of increasing the “bombardment” of metal ions onto the chemical bonds that hold compounds in the coolant together. Such bombardment weakens and may even destroy the chemical bonds making it difficult for the scale or biofilm forming minerals to form hard, needle-like crystalline (calcite) scale. The reduction and/or prevention of scale formation is believed to also reduce the opportunity for bacteria (e.g., biofilm, Legionella) to grow on such scale.

As noted previously, section 20 may also include one or more sensors 20e (e.g., pH and conductivity sensors, temperature and pressure sensors) and valves 20f (air release valves, motorized actuating valves). In embodiments, air release valves may be configured to remove air pockets in piping and aid the flow of a mixture, for example, while motorized actuating valves may aid in the control of the dosing of biocidal ions, for example.

An apparatus 1A,1B,1C,1D may include a booster pump (not shown in Figures). In one embodiment, the booster pump functions to increase the flow rate of the mixture at point 10h flowing through it so that the mixture at point 10i output from the pump may effectively combine or mix with coolant flowing in piping at a higher pressure (e.g., 20 PSI). Absent the booster pump, the treated mixture would not be able to sufficiently mix with coolant that is directed towards the cooling tower 4 (e.g., chiller). In some instances this increase in flow rate may inadvertently damage components of an apparatus 1A,1B, 1C, 1D. For example, during the start-up and/or shutdown of cells 20ba (or 200), pulsating coolant from the booster pump impeller may cause a change in the flow rate, which in turn may result in pressure spikes that travel back through piping towards the plasma cells. To avoid damage to the cells due to such differences in flow rate (e.g., spikes) the inventors provide an isolation means for isolating the cells from such changes in flow rates.

In an embodiment the isolation means may comprise a buffer tank, connective piping and valves for controlling the flow rate (see FIGS. 8A and 8B in the '503 Application for example). The combination of the tank, piping and valves functions to absorb the differences in flow rate (e.g., increases in coolant pressure due to pressure spikes). Without such an isolation means (or its equivalent) to isolate the plasma cells 20ba (or 200) (as well as other components of the apparatus 1A,1B,1C,1D) from flow rate differences (e.g., pressure spikes caused by pulsating coolant from a booster pump or high constant pressures), the flow rate may ultimately cause the quartz plate(s) making up elements of each plasma cell to fail (e.g., crack) and leak.

In one embodiment, the flow rate of coolant flowing into and out of the tank may be controlled between 18 to 22 GPM, for example. Control of the flow rate may be accomplished by the receipt of control signals at the booster pump from a controller 15, for example. Controller 15 may send signals to the pump via communication lines (e.g., data bus 15a, which may be an loT data bus) to control the speed of the booster pump, control the on/off cycle of the pump, control (vary) the opening of a solenoid-actuated ball valves and control the start-up/shut-down flow rates (again, see FIGS. 8A and 8b and the description in the '503 Application, for example).

Yet further, the controller 15 may comprise specialized instructions stored in its memory that cause the controller to complete Al-driven predictive processes to control the operation of the plasma cells in order to optimize plasma exposure cycles, for example.

Further, the inventors discovered that inclusion of the buffer tank, connective piping, and controls discussed herein minimized the number of booster pump on/off cycles, thereby allowing the plasma cells 20ba (or 200) to receive mixture 10e that is flowing at a constant positive pressure. Yet further, the controller 15 may control the flow of mixture to the tank in order to reduce the risk that the buffer tank may overflow or become empty.

In one embodiment the isolation means may further comprise additional elements, such as a level monitoring sensor and coolant level switches which may be controlled by controller 15 for detecting coolant levels of the buffer tank (e.g., low and high levels), wherein the controller 15 may be operable to control a rate at which coolant should be supplied to, or restricted from flowing to, the buffer tank. The details of how the controller and level monitoring sensor work is set forth in full in the '503 Application incorporated by reference herein.

Having presented some exemplary structures and functions of inventive apparatuses 1A,1B,1C,1D we now turn to a discussion of some exemplary configurations describing how the combination of the inventive apparatuses 1A,1B,1C,1D with one or more cooling devices within a data center may be used to increase the efficiency of servers and/or microelectronics within a data center.

In embodiments the inventive apparatuses 1A,1B,1C,1D may be configured within the cooling distribution system of a data center in a number of two ways.

Referring back to FIGS. 1 to 3B, the inventive apparatuses 1A,1B,1C,1D may be connected within a cooling distribution system that is configured as Door Heat Exchanger and/or Rear Door Heat Exchanger (RDHx) cooling distribution system (FIG. 1), Immersion Cooling distribution system (FIG. 2), and/or a Direct to Chip (D2C) or Direct Through Chip cooling distribution system (FIGS. 3A and 3B) one or more of which may incorporate the use of cold plates.

In embodiments, an exemplary coolant may comprise a combination of water and an additive, such as glycol and, in addition, one or more dielectric fluids for immersion cooling.

In each of the configurations illustrated by FIGS. 1 to 3B the apparatuses 1A,1B,1C,1D may be connected within a secondary, side-stream cooling loop to ensure optimal exposure time of the coolant to applied plasma without having to disrupt the primary coolant flow of the FWS.

For the sake of brevity we now provide some features and functions of each of the inventive apparatuses 1A,1B,1C,1D illustrated in FIGS. 1 to 3B rather than discuss each one separately.

In an embodiment, the inventive apparatuses 1A,1B,1C,1D may include a coolant distribution unit (CDU) to provide targeted contaminant removal in liquid-cooled servers.

Further, an exemplary apparatus 1A,1B,1C,1D may be configured to generate plasma discharges that are less than 5% power loss operating at thermal loads exceeding 250 W/cm². Said another way, the generation of discharges is 95% efficient (i.e., uses 95% of the power available per watt).

Each of the inventive apparatuses 1A,1B,1C,1D may generate nonthermal plasma and apply the nonthermal plasma in a pulsating duty cycle mode to extend the operational lifespan of coolant being treated by such nonthermal plasma. Further, each of the inventive apparatuses 1A,1B,1C,1D may be installed or retrofitted into an existing liquid cooling infrastructure (e.g., of a data center) without requiring pump pressure or flow rate modifications because the inventive apparatuses 1A,1B,1C,1D are installed in a secondary or side stream configuration and the inventive apparatuses 1A,1B,1C,1D have their own recirculation pumps and maintain their own coolant flow rate.

The inventors believe the inventive apparatuses described herein provide at least the following advantages over existing methods, systems and devices.

### Microbiological Contaminant Elimination

The inventive apparatus 1A,1B,1C,1D may eliminate up to 99.9% of microbiological contaminants in a liquid coolant loop, including, but not limited to, E. coli, S. aureus, P. aeruginosa, and Legionella pneumophila.

By applying nonthermal plasma to a coolant the inventors believe that the inventive apparatus 1A,1B,1C,1D may reduce biofilm formation in coolant within microcapillaries that function to transport coolant to and from heatsinks of a microelectronic device (e.g., CPUs, GPUS) (i.e., inactivate microbials) by generating hydroxyl radicals (OH), ozone (O₃), hydrogen peroxide (H₂O₂), and singlet oxygen (¹O₂) at concentrations below 0.05 ppm.

Compared to chemical biocides, the inventive apparatuses 1A,1B,1C,1D that use nonthermal plasma achieve superior microbial deactivation without leaving harmful chemical residue on wetted surfaces of microelectronics and other surfaces.

### Nonthermal Plasma (NTP) Efficiency & Safety

An inventive apparatus 1A,1B,1C,1D can operate at near-room temperatures, ensuring minimal thermal impact on high-performance computing (HPC) cooling systems.

The dielectric barrier discharge (DBD) plasma configuration of each inventive apparatus 1A,1B,1C,1D may generate low-energy streamers, optimizing energy consumption while maintaining high disinfection efficacy. In more detail, at 1-5% of its rated power, the inventive apparatuses remains effective for slow bacterial and viral inactivation, though they may require extended exposure times of over 5 minutes to achieve significant microbial reduction. Further, in embodiments, increasing to 5-10% of their rated power enhances the generation of reactive oxygen and nitrogen species (RONS) and UV radiation by the inventive apparatus 1A,1B,1C,1D, allowing for faster microbial killing within 1-3 minutes, for example. At 10-20% of its rated power, the inventive apparatus inventive apparatuses 1A,1B,1C,1D reach near-optimal efficiency, effectively breaking down biofilms and providing rapid sterilization.

Each inventive apparatus 1A,1B,1C,1D meets or exceeds ISO 11138-1 and ASTM E2315 standards for microbial deactivation in liquid cooling environments.

### Compatibility with Liquid Cooling Systems

The inventive apparatuses 1A,1B,1C,1D integrates seamlessly into Door Heat Exchanger and/or Rear Door Heat Exchanger (RDHx) cooling distribution systems, Immersion Cooling distribution systems, and/or a Direct to Chip (D2C) or Direct Through Chip cooling distribution systems without disrupting fluid dynamics.

Because the inventive apparatuses 1A,1B,1C,1D may be connected within a secondary or side-stream loop of a cooling distribution system the inventive apparatus enable treatment of coolant without the need to shut down the flow of coolant within an FWS, thus ensuring optimal residence time which helps to prevent plasma-induced degradation of cooling liquids.

In embodiments, each of the inventive apparatuses 1A,1B,1C,1D may be separated into one or more individual modules which the inventors believe allows scalability across data centers, enabling rapid deployment and minimal infrastructure modification.

### Corrosion & Material Integrity Protection

Components of the inventive apparatuses 1A,1B,1C,1D, such as electrodes, cells and piping may employ corrosion-resistant materials, including PEEK, DELRIN, stainless steel (316L), and titanium, preventing oxidative damage from residual reactive species.

The inventive apparatuses 1A,1B,1C,1D (i.e., controller 15 and one or more sensors disclosed elsewhere herein) may balance the amount of reactive oxygen and nitrogen species (ROS/RNS) to prevent excessive reactive species that may cause corrosion in GPU microcapillary channels, for example.

Accelerated aging condition-based experiments have revealed that coolant treated by the inventive apparatuses 1A,1B,1C,1D exhibits at least 30% lower corrosion rates than traditional chemical biocide-treated coolants.

### Energy & Operational Efficiency for Data Centers

The inventive apparatuses 1A,1B,1C,1D may reduce cooling system energy consumption by up to 40%, eliminating the need for intermittent chemical dosing and mechanical cleanings by reducing or removing biofilm through the generation of reactive oxygen and nitrogen species (RONS) by applying NTP to the coolant which oxidizes and degrades an extracellular polymeric matrix. NTP-induced electric fields, ion bombardment, and UV exposure physically disrupt biofilm cohesion, while oxidative stress damages microbial membranes, proteins, and DNA, leading to cell death. Additionally, the application of plasma modifies surface properties, increasing hydrophilicity to prevent biofilm regrowth, thus effectively eliminating biofilm(s), even antibiotic-resistant strains.

By controlling biofilm growth, the inventive apparatuses 1A,1B,1C,1D improve Power Usage Effectiveness (PUE) by at least 10%, directly benefiting AI and high performance computing (HPC) data centers.

Compared to existing, conventional biocidal treatment, the inventive apparatuses 1A,1B,1C,1d may extend the lifespan of a coolant by at least 2×, reducing maintenance frequency and total cost of ownership (TCO).

### Enhanced Liquid Coolant Stability & Performance

In embodiments, the inventors believe that Perfluoropolyether (PFPE) coolants (e.g., Galden®, Krytox®, 3M Fluorinert™) are highly effective dielectric coolants when used in combination with the inventive apparatuses 1A,1B,1C,1D that apply nonthermal plasma to such coolants, Such coolants offer high stability due to strong C—F bonds, making them chemically inert, oxidation-resistant, and non-ionizing under exposure to applied plasma. These coolants are believed to maintain high dielectric strength, low volatility, and zero water absorption, preventing degradation.

Alternatively, silicone-based coolants are a lower-cost alternative but can degrade under prolonged UV and ionizing radiation. Thus, PFPEs are ideal for long-term plasma applications despite their higher cost.

The inventive apparatuses 1A,1B,1C,1D: (i) prevent the degradation of glycol-based coolants by mitigating oxidation and reactive species accumulation through the inclusion of a catalytic neutralization unit 9a, 9b,9c,9d (e.g., a recirculation tank) that facilitates the complete decomposition of oxidative byproducts in an inventive apparatuses 1A,1B,1C,1D by continuously passing fluid through a catalyst bed; (ii) maintaining the pH of the glycol-based coolants between 7.5 and 9.0 to ensuring stable, optimal heat transfer performance and material compatibility; and (iii) when used with optimized additive formulations, the inventive apparatus extends coolant lifespan by at least 50% in closed-loop systems.

In more detail, the catalytic neutralization unit (9a, 9b,9c,9d e.g., a recirculation tank) is used to remove oxidative byproducts. The recirculation tank may be installed in the same loop as an inventive apparatus 1A,1B,1C,1D to ensure complete decomposition of oxidative byproducts generated by apparatus 1A,1B,1C,1D by continuously passing fluid through a catalyst bed. In embodiments, the exemplary catalytic neutralization units 9a, 9b,9c,9d may comprise: a sealed tank (sealed, non-reactive) for holding a coolant (correct??) to be treated treatment, a catalyst bed (e.g., MnO₂ for O₃ removal, Cu-Zeolite for removing NOₓ, TiO₂ for removing VOCs, Fe₂O₃/CuO for removing H₂O₂), a pump/blower for circulating the coolant for repeated catalyst contact, inlet & outlet ports for controlling the flow of the coolant. In an embodiment, the coolant may be received into the recirculation tank.

In an embodiment, as the coolant flows through the catalyst bed for oxidation breakdown, a pump built into the inventive apparatus 1A, 1B,1C,1D or an external pump recirculates the coolant multiple times to decompose oxidative byproducts

Further, to maintain the pH of a glycol-based coolant between 7.5 and 9.0, buffered inhibitors and the pH may be monitored regularly with a digital meter. In an embodiment, adjusting the pH of such a coolant can be achieved by adding NaOH/KOH (to raise) or phosphoric/citric acid (to lower) in controlled amounts. Further, to ensure a correct glycol-to-water ratio deionized or distilled water may be used to prevent mineral buildup. Contamination may be avoided by not mixing different coolant types and periodically flushing the cooling system. Still further, using coolant conditioners that maintain pH, prevent corrosion, and enhance thermal efficiency, or buffering agents (e.g., borate, silicate, or phosphate buffers) may help stabilize the coolant pH over time, ensuring optimal heat transfer and material compatibility. In addition, using pH stabilizers (e.g., Fleetguard DCA4) may help balance acidity, while corrosion inhibitors such as Zerex Super Protector protects metals. OAT conditioners like Zerex G-05 extend coolant life, and antifoam additives like Royal Purple Ice improve heat transfer. Industrial options like Nalco 2000 suit large systems.

### Reduction of Algae and Organic Fouling in Liquid Cooling Loops

The inventive apparatuses 1A,1B,1C,1D: (i) prevent algal blooms by disrupting photosynthetic pathways through high-energy plasma-generated UV and oxidative radicals; (ii) may effectively treat both planktonic and sessile microorganisms in opaque and light-exposed cooling systems, unlike conventional UV sterilization; and (iii) subject coolant to continuous plasma exposure to maintain a microbial load in the coolant to a level below industry thresholds (<100 CFU/mL), which helps improve long-term system reliability (i.e., of a data center, server, or microelectronics).

### Alternative Coolant Compatibility & Performance

The inventive apparatuses 1A,1B,1C,1D are compatible with P25 Glycol-Water, Fluorinated Fluids (Novec™, Fluorinert™), Synthetic Hydrocarbons, and Silicone-Based Dielectric Liquids.

Table 1 sets forth a detailed comparison evaluating the various dielectric coolants against P25 Glycol-Water (with Additives). This comparison addresses NTP stability, thermal performance, costs, environmental impact, and the key additives utilized.

When combined with an ester-based dielectric coolants (e.g., Midel® 7131) coolants within cooling loops shown in FIGS. 1 to 3B (e.g., a glycol mixture) that undergo applied plasma treatment from the inventive apparatuses 1A, 1B,1C,1D maintain low viscosity and high thermal conductivity without inducing phase instability.

Compared to untreated glycol-water systems, when the inventive apparatuses 1A,1B,1C,1D are used to treat glycol mixtures the inventive apparatuses 1A,1B,1C,1D help maintain such a coolant at 99% of its original heat transfer efficiency after 12 months of operation of the inventive apparatuses 1A,1B,1C,1D.

### Scalable and Future-Proofed Design

The inventive apparatuses 1A,1B,1C,1D: (i) can operate under a wide range of liquid cooling conditions, from ambient to high-performance thermal loads (>250W/cm²) in AI and GPU servers; (ii) meet ASHRAE TC 9.9 liquid cooling guidelines, ensuring compatibility with next-generation edge, cloud, and AI computing infrastructures; (iii) can be inserted and/or included within existing liquid-cooling management systems (LCMS) using standard industrial communication protocols (e.g., Modbus, BACnet, SNMP).

In more detail, by integrating or positioning the inventive apparatuses 1A, 1B,1C,1D within a liquid cooling loop enables smart monitoring and ensures scalability for high-performance workloads, as well as maintaining redundancy. The inventive apparatuses 1A,1B,1C,1D enhance the efficiency, reliability, and longevity of liquid-cooled AI, CPU, GPU, and cloud computing infrastructures while ensuring full ASHRAE TC 9.9 compliance.

What is claimed is:

1. An apparatus for applying nonthermal plasma to a liquid coolant to control contaminant growth comprising:
a plasma disinfection system that applies nonthermal plasma to a liquid coolant to control contaminant growth in the liquid coolant, the plasma disinfection system further configured to generate reactive oxygen and nitrogen species upon application of the nonthermal plasma to the liquid coolant, the plasma disinfection system further comprising:
one or more dielectric barrier discharge (DBD) electrodes configured to optimize energy efficiency;
an electronic controller that controls a time period that the nonthermal plasma is applied to the liquid coolant; and
a neutralization unit that removes residual oxidants.

2. The apparatus as in claim 1 wherein the apparatus is connected to a secondary or side stream cooling distribution loop to treat the liquid coolant.

3. The apparatus as in claim 1 wherein the apparatus is connected inline.

4. The apparatus as in claim 1 wherein the electronic controller further controls a voltage or frequency of the nonthermal plasma applied to the liquid coolant.

5. The apparatus as in claim 1 wherein the DBD electrodes are composed of a corrosion-resistant material.

6. The apparatus as in claim 5 wherein the corrosion resistant material comprises one of PEEK, DELRIN, titanium, or 316L stainless steel.

7. A method for reducing biofilm and microbiological contaminants in a liquid cooling distribution system comprising:
connecting a plasma disinfection system into a liquid cooling loop of the system;
applying nonthermal plasma from the plasma disinfection system to the liquid coolant to generate oxidative species including hydroxyl radicals (OH), ozone (O₃), hydrogen peroxide (H₂O₂), and singlet oxygen (¹O₂) to inactivate microbial contaminants;
neutralizing excess levels of the oxidative species before re-entry into the liquid cooling loop; and
monitoring the pH and the oxidation reduction potential of the liquid coolant.

8. The method as in claim 7 wherein the method further comprises controlling the application of nonthermal plasma from the plasma disinfection system to the liquid coolant to generate hydroxyl radicals (OH), ozone (O₃), hydrogen peroxide (H₂O₂), and singlet oxygen (¹O₂) at controlled dosages withing 200 mV to 400 mV ORP levels.

9. The method as in claim 7 further comprising monitoring the conductivity or microbial load of the liquid coolant.

10. A self-regulating apparatus for applying nonthermal plasma to a liquid coolant to control contaminant growth comprising in data center microelectronics comprising:
a real-time microbial contamination sensor for detecting a microbial load;
an automated plasma power regulation module for controlling the application of nonthermal plasma to a coolant based on the detected microbial load and a quality of the liquid coolant;
a dual-stage nonthermal plasma chamber that generates and applies nonthermal plasma to a liquid coolant to optimize exposure time in a cooling loop and
an electronic controller that controls the dual-stage nonthermal plasma chamber to generate nonthermal plasma over a variable plasma duty cycle to reduce energy consumption while maintaining a microbial load of 10 CFU/ml.

11. The apparatus as in claim 10 wherein the electronic controller comprises wireless circuitry for operating remotely from the chamber.

12. The apparatus as in claim 11 further comprising an electronic communications bus for communicating electronic signals using a network protocol comprising one of Modbus, BACnet or SNMP.

13. A method for applying nonthermal plasma to an enhanced glycol-water coolant mixture used in a data center comprising:
applying a controlled amount of nonthermal plasma to the enhanced glycol-water coolant mixture;
mitigating glycol oxidation by introducing antioxidants (BHT, TBHQ), metal chelators (EDTA, phosphonates), and corrosion inhibitors (molybdates, benzotriazole) into the glycol-water coolant mixture;
maintaining a pH of the enhanced glycol-water coolant mixture within the range of 7.5-9.0;
reducing biofilm growth within the glycol-water mixture flowing to or through microcapillaries of graphical processing units (GPUs); and
reducing biofilm growth within the glycol-water mixture flowing in one or more cooling distribution loops that includes one or more electronic servers.

14. The method as in claim 13 wherein the enhanced glycol-water coolant mixture is composed of a propylene glycol based coolant.

15. The method as in claim 14 wherein the propylene glycol based coolant comprises a PG25 propylene glycol coolant.

16. The method as in claim 13 wherein the enhanced glycol-water coolant mixture is composed of an ethylene glycol coolant.

17. A modular apparatus for applying nonthermal plasma to a liquid coolant to control contaminant growth within a closed-Loop liquid cooling distribution system of a data center, the apparatus comprising:
a plasma disinfection module connected to the closed-Loop liquid cooling distribution system;
a plasma energy optimization system that minimizes power consumption based on cooling system parameters;
corrosion-resistant piping that prevents oxidative degradation;
a fail-safe monitoring system for plasma streamer discharge, coolant quality, and system health diagnostics; and
a modular skid-mounted PDS unit for rapid deployment in new or existing data centers.

18. The apparatus as in claim 17 wherein the closed-Loop liquid cooling distribution system comprises a Door Heat Exchanger system or Rear Door Heat Exchanger (RDHx) system.

19. The apparatus as in claim 17 wherein the closed-Loop liquid cooling distribution system comprises a Direct-to-Chip (D2C) system or a Direct Through Chip system.

20. The apparatus as in claim 17 wherein the closed-Loop liquid cooling distribution system comprises an Immersion Cooling system.
